(19) United States
(12) Patent Application Publication
(10) Pub. No.: US 2015/0026038 A1
(43) Pub. Date: Jan. 22, 2015

(54) LOAN ORIGINATION SYSTEM

(71) Applicant: Stephanie ALSBROOKS, Colleyville, TX (US)

(72) Inventor: Stephanie ALSBROOKS, Colleyville, TX (US)

(73) Assignee: DEFI SOLUTIONS, Grapevine, TX (US)

(21) Appl. No.: 14/333,441

(22) Filed: Jul. 16, 2014

Related U.S. Application Data
(60) Provisional application No. 61/846,752, filed on Jul. 16, 2013.

(51) Int. Cl. G06Q 40/02

(52) U.S. Cl. CPC G06Q 40/025
USPC 705/38

(57) ABSTRACT

A customizable loan origination technique performed by a computing device including one or more tangible computing elements. The technique includes accepting plural sets of rules for approving or disapproving loans, accepting information related to at least one set of rules of the plural sets of rules from at least one dealer, applying at least the one set of rules to the information to decide whether to approve or disapprove a loan, and providing approval or disapproval of the loan to the dealer. In some aspects, one or more of the rules are based on predefined and/or customized parameters. Also, systems configured to perform the technique.

### CROSS-REFERENCE TO RELATED APPLICATION

This application claims the benefit of U.S. Provisional Application No. 61/846,752 titled “LOAN ORIGINATION SYSTEM” and filed 16 Jul. 2013 in the name of the same inventor as this non-provisional application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND

The present disclosure generally relates to a customizable loan origination system.

### SUMMARY

Aspects of the subject technology include a customizable loan origination technique performed by a computing device including one or more tangible computing elements. The technique includes accepting plural sets of rules for approving or disapproving loans, accepting information related to at least one set of rules of the plural sets of rules from at least one dealer, applying at least the one set of rules to the information to decide whether to approve or disapprove a loan, and providing approval or disapproval of the loan to the dealer. In some aspects, one or more of the rules are based on predefined and/or customized parameters.

Applying the one set of rules to the information may include displaying a matrix showing plural combinations of the information that result in approved loans and disapproved loans and accepting selection of one of the plural loans for approval. In some aspects, providing approval or disapproval of the loan to the dealer may include displaying a matrix to the dealer showing plural combinations of the information that result in approved loans and disapproved loans. The matrix may include one dimension for each of the rules in the one set of rules, and displaying the matrix may include displaying different views of the matrix as requested.

The technique may also include requesting additional information to qualify an approved loan and sending loan notifications based on the qualified approved loan. The loan notifications may be customized, for example by a lender.

The subject technology also includes systems configured to perform the above techniques.

This brief summary has been provided so that the nature of the invention may be understood quickly. Additional steps and/or different steps than those set forth in this summary may be used. A more complete understanding of the invention may be obtained by reference to the following description in connection with the attached drawings.

### BRIEF DESCRIPTION OF THE DRAWINGS

FIG. 1 illustrates an example of a configuration screen for a loan origination system according to aspects of the subject technology.

FIG. 2 illustrates an example of a screen that may provide access to configuration screen, set-up wizards, or queues according to aspects of the subject technology.

FIG. 3 illustrates an example of a configuration screen according to aspects of the subject technology.

FIG. 4 illustrates an example of a screen through which access to “multiple-decisioning” by a dealer may be enabled or disabled according to aspects of the subject technology.

FIG. 5 illustrates an example of a screen through which a user may set up one or more matrices for acceptable loan structures according to aspects of the subject technology.

FIG. 6 illustrates an example of a screen through which a user may customize a matrix for an acceptable loan structure according to aspects of the subject technology.

FIG. 7 illustrates an example of a screen through which a user may set up rules to define which of plural matrices is used according to aspects of the subject technology.

FIG. 8 illustrates an example of a screen through which a user may select loan terms according to aspects of the subject technology.

FIG. 9 illustrates an example of a screen through which a user may update and index loan documents according to aspects of the subject technology.

FIG. 10 illustrates an example of a screen through which a user may answer loan related questions set up by an administrator according to aspects of the subject technology.

FIG. 11 illustrates an example of a screen shown pass/fail loan decisions generated by a decision engine according to aspects of the subject technology.

FIGS. 12 to 109 illustrate further details of an example loan origination system according to aspects of the subject technology.

FIGS. 110 to 130 illustrate details of further possible functionality of an example loan origination system according to aspects of the subject technology.

### DETAILED DESCRIPTION

U.S. Provisional Application No. 61/846,752 titled “LOAN ORIGINATION SYSTEM” and filed 16 Jul. 2013 in the name of the same inventor is hereby incorporated by reference as if fully set forth herein.

Conventional loan origination systems also often do not provide much flexibility for underwriting loans and for providing plural decisions regarding whether or not a potential borrower qualifies for acceptable loan terns. As a result, originating one loan often requires repeatedly re-hashing loan terms. Aspects of the subject technology address this issue based on the fact that lenders often know ahead of time what kinds of loans they will be willing to approve.

In some aspects, a lender can set up matrices defining plural set of rules for plural acceptable loan structures. This process may include designating plural parameters and values for those parameters representing plural structures for acceptable loans. Preferably, three variables are used to define terms for an acceptable loan; however, this need not be the case. The facts representing a potential borrower's situation can be compared to these plural sets of loans to determine which ones may be offered to the borrower.

The information about a borrower's situation and the results of this plural decision process are often transmitted through a third party called a “dealer.” Thus, aspects of the subject technology may be configured by a lender and then access to parts of the technology may be made available to dealers. Thus, users of aspects of the loan origination system may be people at lenders and/or dealers. Display of parameters and related information to the lender and/or dealer also may be customizable, facilitating use of the loan origination system.

In more detail, aspects of the subject technology include a customizable loan origination technique performed by a computing device including one or more tangible computing elements. The technique includes accepting plural sets of rules for approving or disapproving loans, accepting information related to at least one set of rules of the plural sets of rules from at least one dealer, applying at least the one set of rules to the information to decide whether to approve or disapprove a loan, and providing approval or disapproval of the loan to the dealer. In some aspects, one or more of the rules are based on predefined and/or customized parameters.

Applying the one set of rules to the information may include displaying a matrix showing plural combinations of the information that result in approved loans and disapproved loans and accepting selection of one of the plural loans for approval. In some aspects, providing approval or disapproval of the loan to the dealer may include displaying a matrix to the dealer showing plural combinations of the information that result in approved loans and disapproved loans. The matrix may include one dimension for each of the rules in the one set of rules, and displaying the matrix may include displaying different views of the matrix as requested.

The technique may also include requesting additional information to qualify an approved loan and sending loan notifications based on the qualified approved loan. The loan notifications may be customized, for example by a lender.

Examples of configuration and other screens that may be used with the subject technology are shown in the figures. The subject technology is not limited to the specific details of the example screens, but rather encompasses the techniques and principals enabled by the screens.

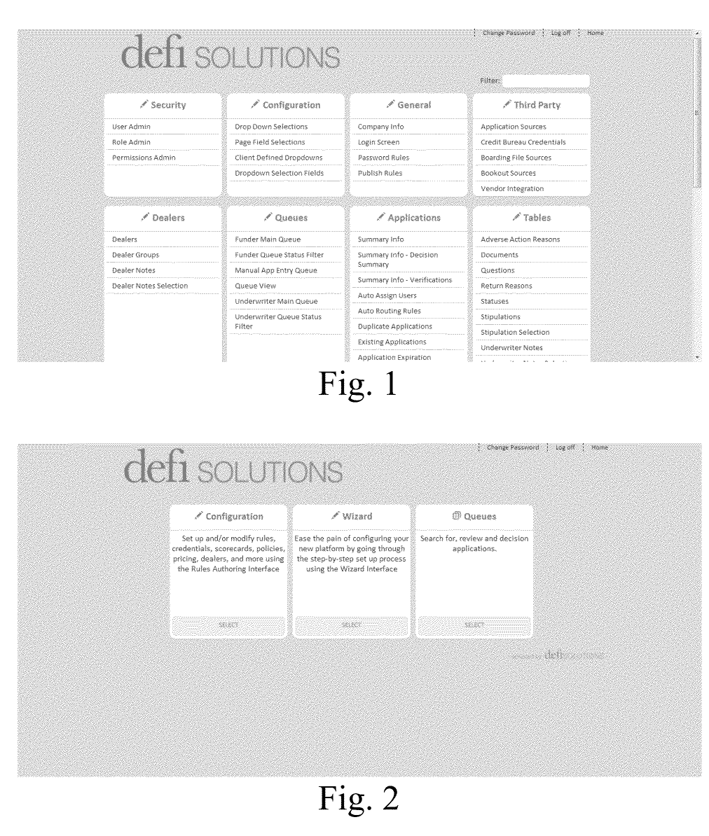

FIG. 1 illustrates an example of a configuration screen for a loan origination system according to aspects of the subject technology. FIG. 2 illustrates an example of a screen that may provide access to configuration screen, set-up wizards, or queues according to aspects of the subject technology.

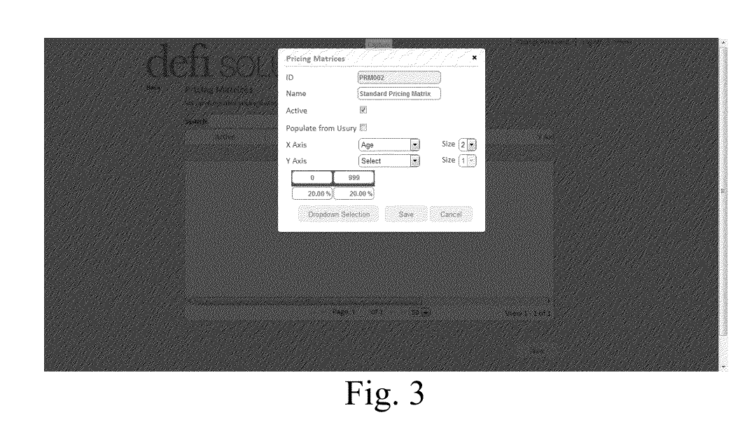

FIG. 3 illustrates an example of a configuration screen according to aspects of the subject technology. This basic configuration screen permits selection of pre-defined parameters for axes of a matrix representing loans that may be approved or disapproved. Further screen may permit specifying rules, for example a range of acceptable values, for approving a loan.

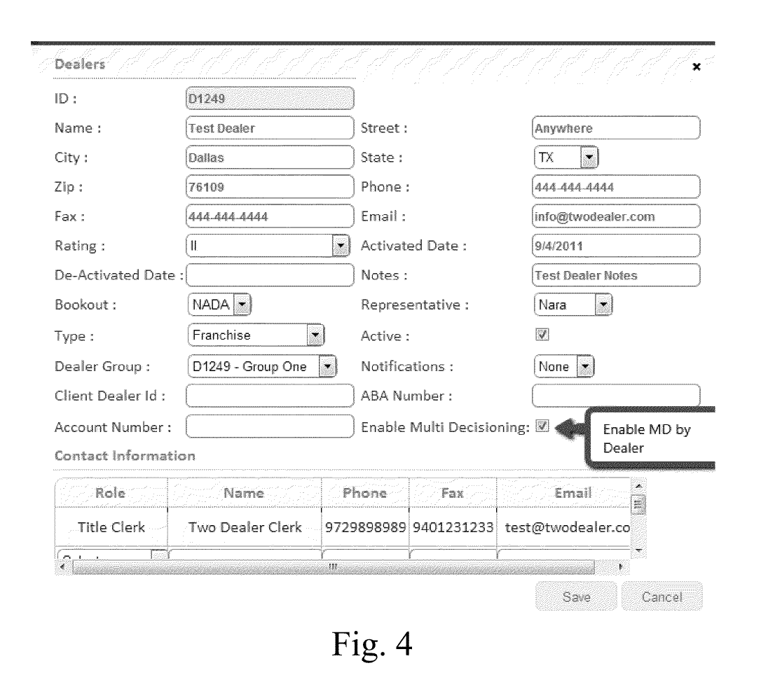

FIG. 4 illustrates an example of a screen through which access to “multiple-decisioning” by a dealer may be enabled or disabled according to aspects of the subject technology. “Multiple-decisioning” refers to applying information supplied by a dealer to plural rules and determining multiple decisions about approval or disapproval of loans structured in different ways. Multiple-decisioning may be performed with respect to one set of rules or with respect to plural sets of rules.

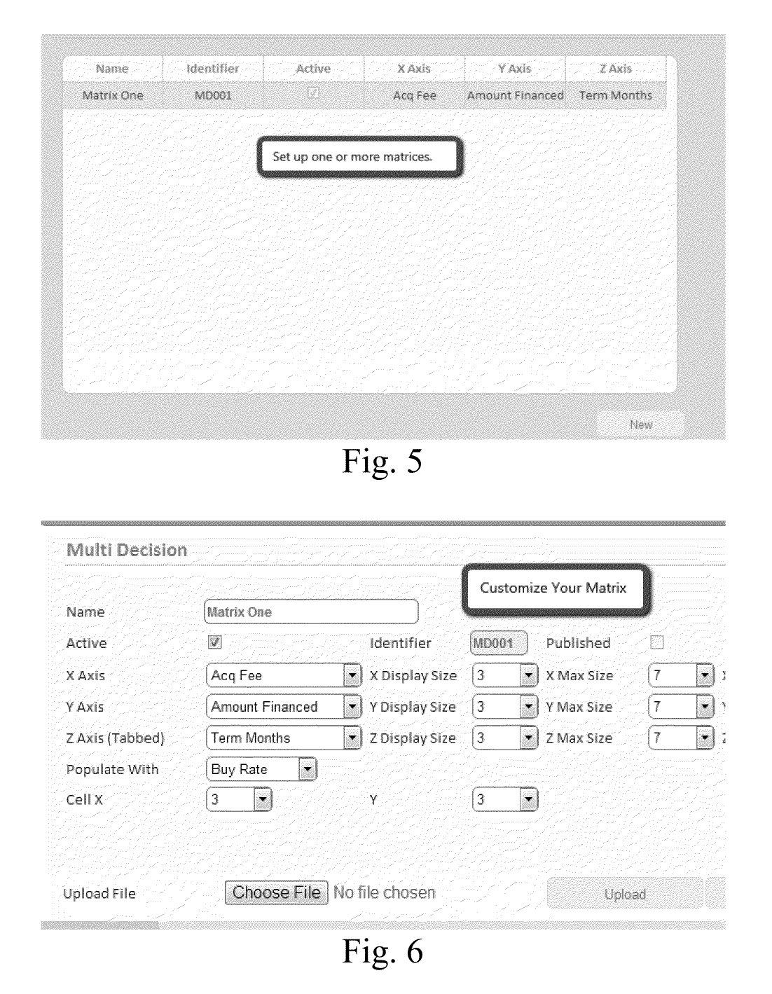

FIG. 5 illustrates an example of a screen through which a user may set up one or more matrices for acceptable loan structures according to aspects of the subject technology. FIG. 6 illustrates an example of a screen through which a user may customize a matrix for an acceptable loan structure according to aspects of the subject technology. As shown in FIG. 6, the matrix has three dimensions: Acquisition (Acq) Fee, Amount Financed, and Term Months. Display sizes for the axes may be customized. In addition, the matrix may be customized before publication to dealers and/or for use.

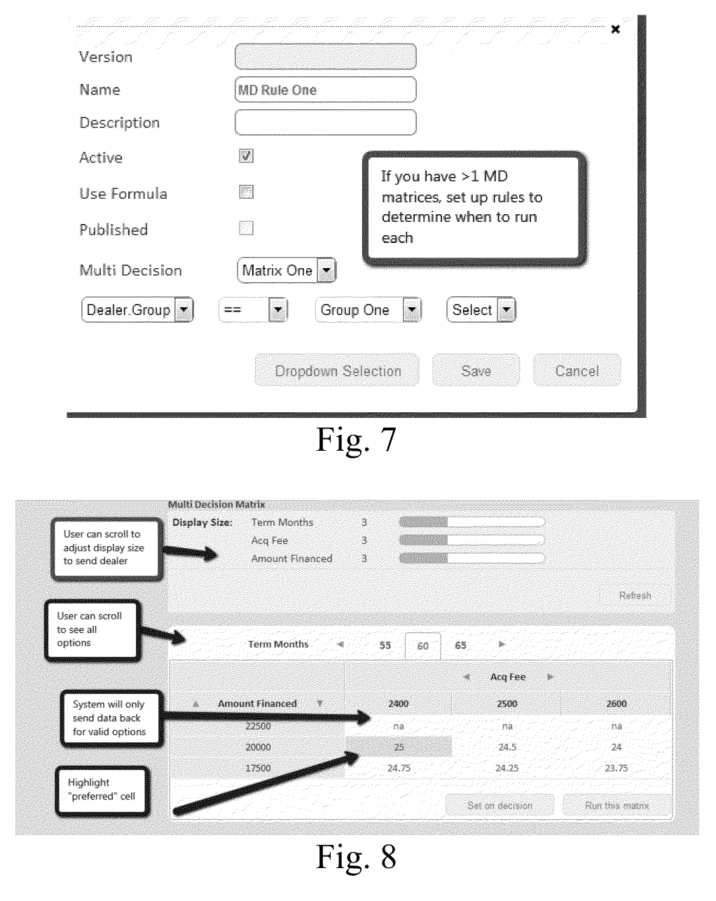

FIG. 7 illustrates an example of a screen through which a user may set up rules to define which of plural matrices is used according to aspects of the subject technology. In some aspects, rules can be set up to define when each different matrix is used. For example, one matrix could be used with a first set of dealers, another matrix could be used for a second set of dealers, etc.

FIG. 8 illustrates an example of a screen through which a user may select loan terms according to aspects of the subject technology. In some aspects of the subject technology, a decision engine can create the matrices based on the configuration and display one or more of them to a lender and/or dealer(s). Some possible features of the display include but are not limited to an ability to scroll the displayed matrix, to change a size of a displayed matrix, and to “lock in” one matrix and then move a cell representing a point of interest around within the displayed matrix.

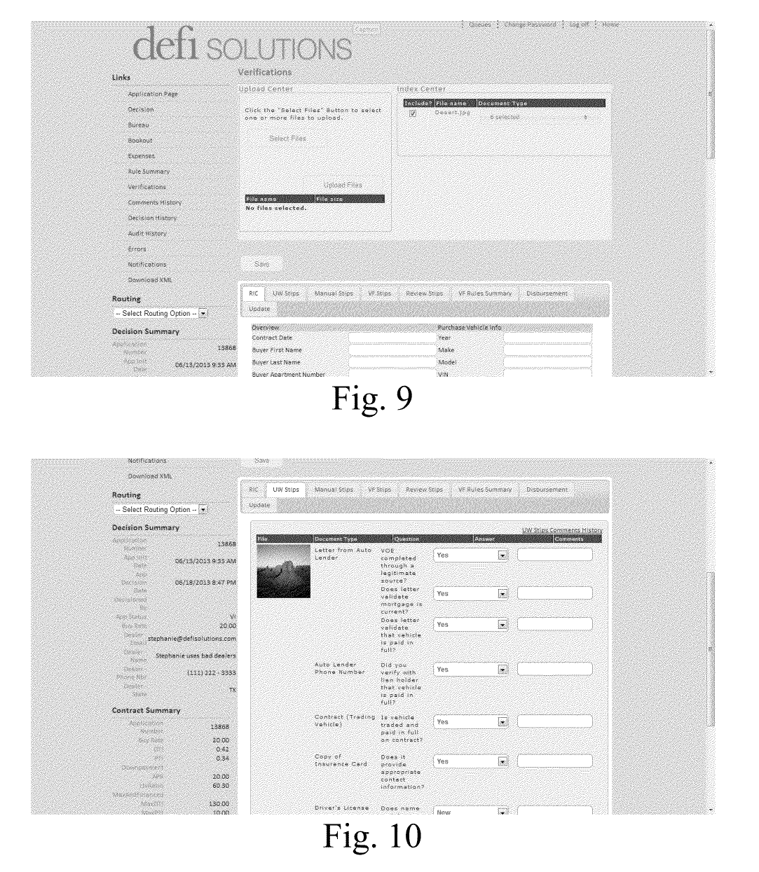

FIG. 9 illustrates an example of a screen through which a user may update and index loan documents and/or notifications according to aspects of the subject technology. Loan terms may be generated based on a selected cell representing a particular dealer and loan terms. Those terms may be sent to a dealer for approval.

The foregoing process of configuring matrices defining acceptable loans may be used in the context of an overall integrated system. Alternatively, the process may be used as a “plug in” for other existing loan origination systems. For some third party integrations, the system can include a configuration screen to enable users to make changes regarding what goes back and forth in the XML.

Verifying loan terms in the context of conventional loan origination systems also may be cumbersome. When documents (e.g., a contract, proof of identity, odometer, proof of residence, etc.) are received for verification, much of the data must be entered by hand, manually reviewed, and then approved (or disapproved). Aspects of the subject technology address this issue by at least partially automating the loan verification process through automated transmission of notifications to dealer(s) and/or other parties. The notifications may be customized based on the type of loan, dealer, and/or other factors.

For example, configuration screens may be used by an administrator to define what tasks a user should perform. Verification may then involve simply entering in the appropriate information matching those tasks, and a decision engine may automatically review the information to make a loan verification decision (i.e., pass or fail).

FIG. 10 illustrates an example of a screen through which a user may answer loan related questions set up by an administrator according to aspects of the subject technology. For example, the loan origination system may collect information about what documents necessary (or desirable) to close a loan have been acquired. Notifications may be sent out regarding documents that have not been acquired.

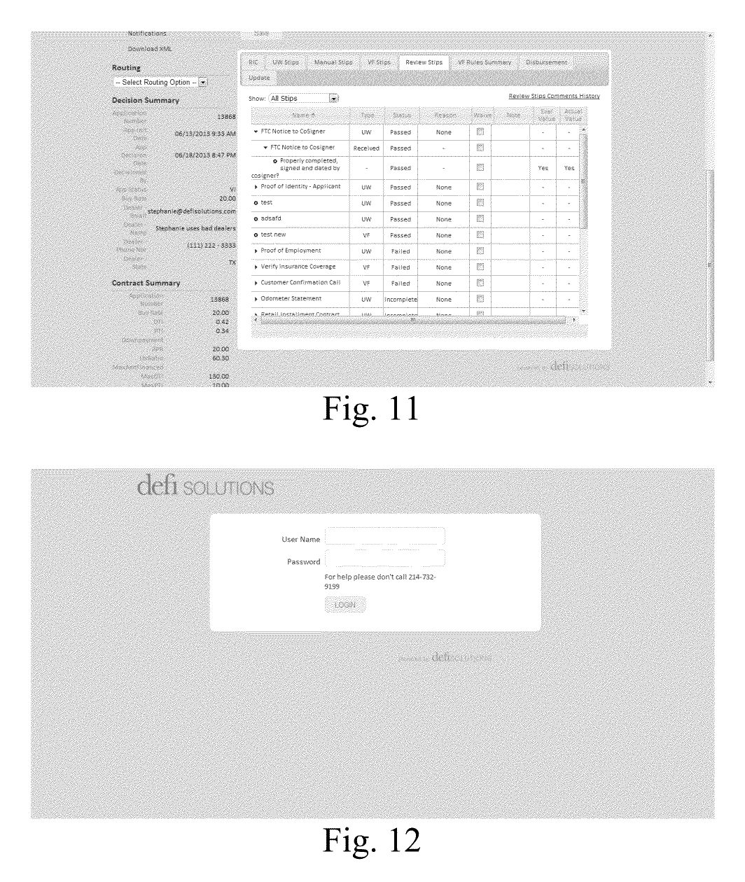

FIG. 11 illustrates an example of a screen shown pass/fail loan decisions generated by a decision engine according to aspects of the subject technology. The decisions preferably are based on the rule matrix being used and information from the dealer corresponding to that rule matrix.

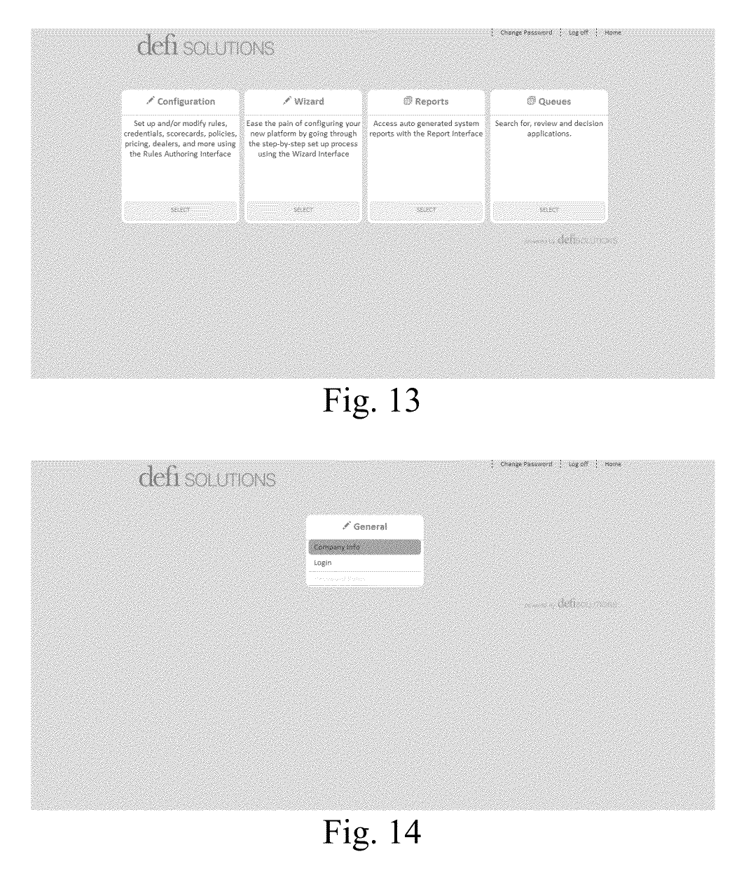

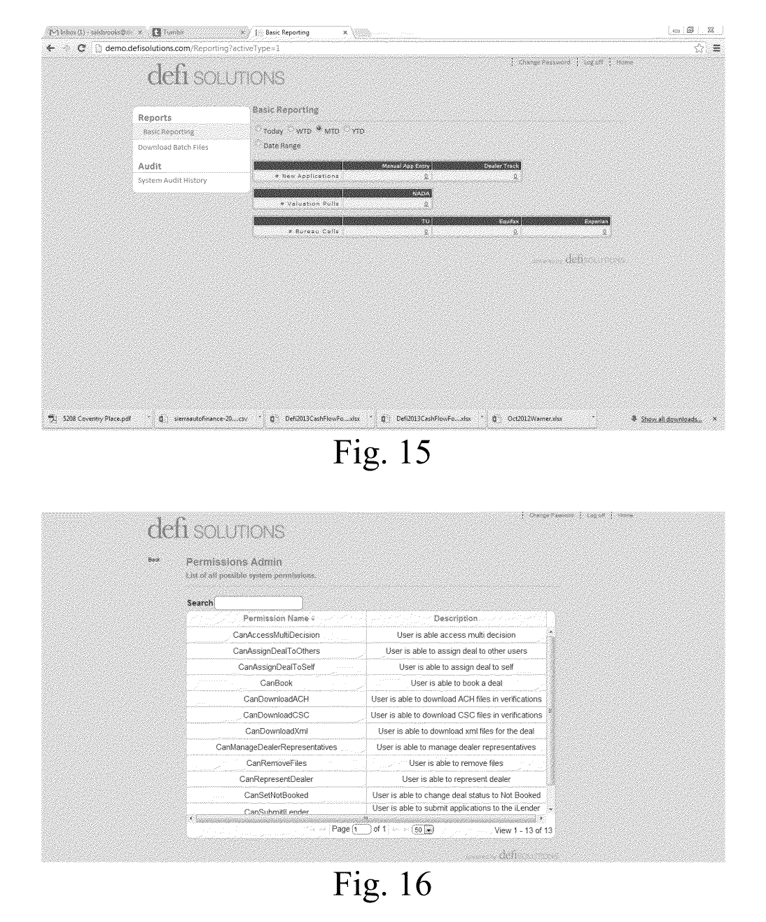

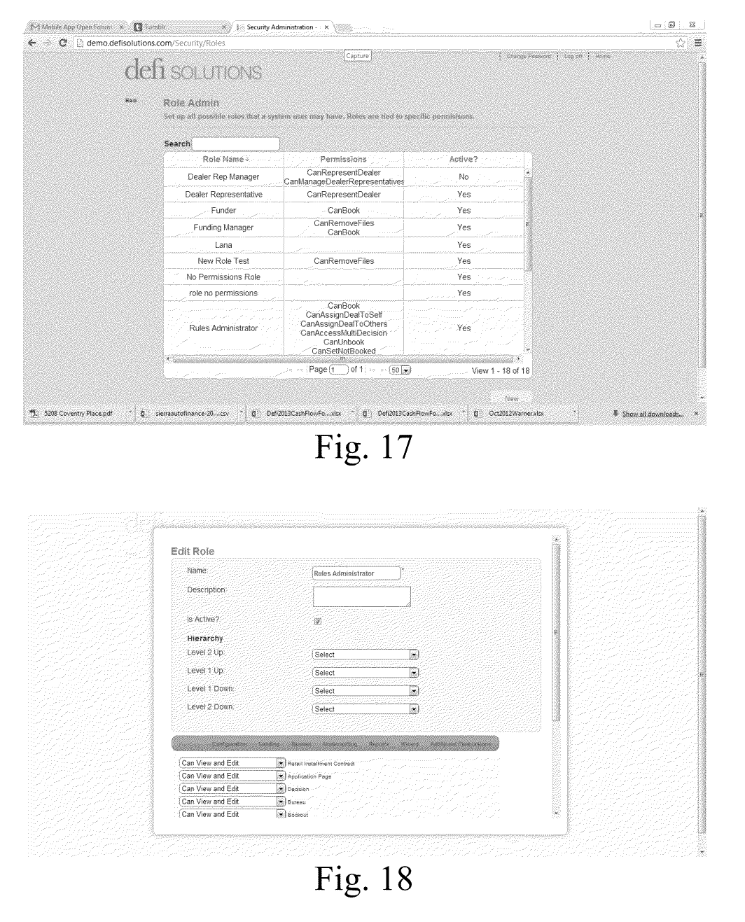

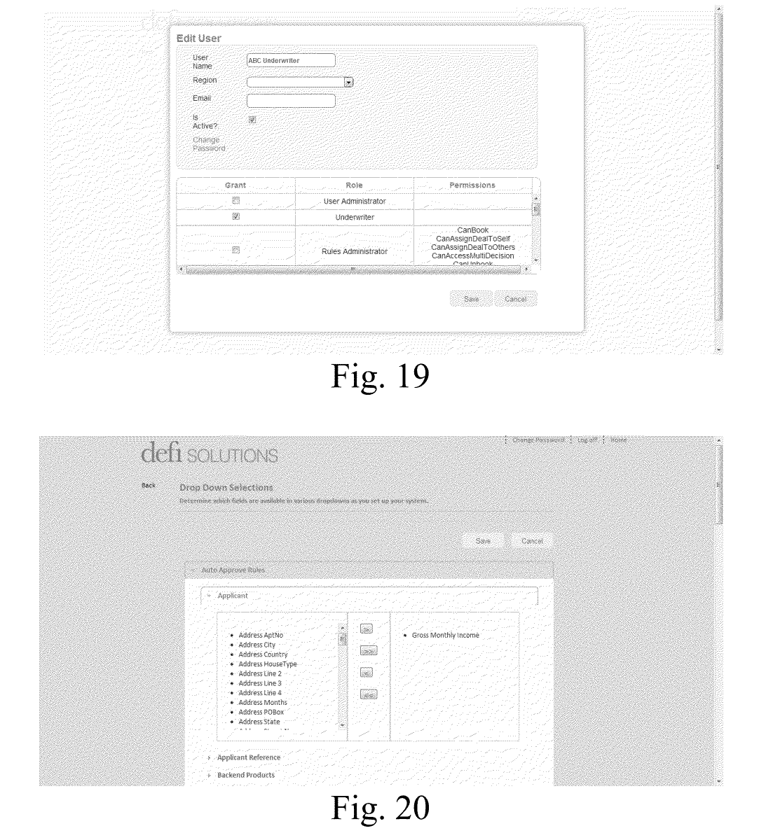

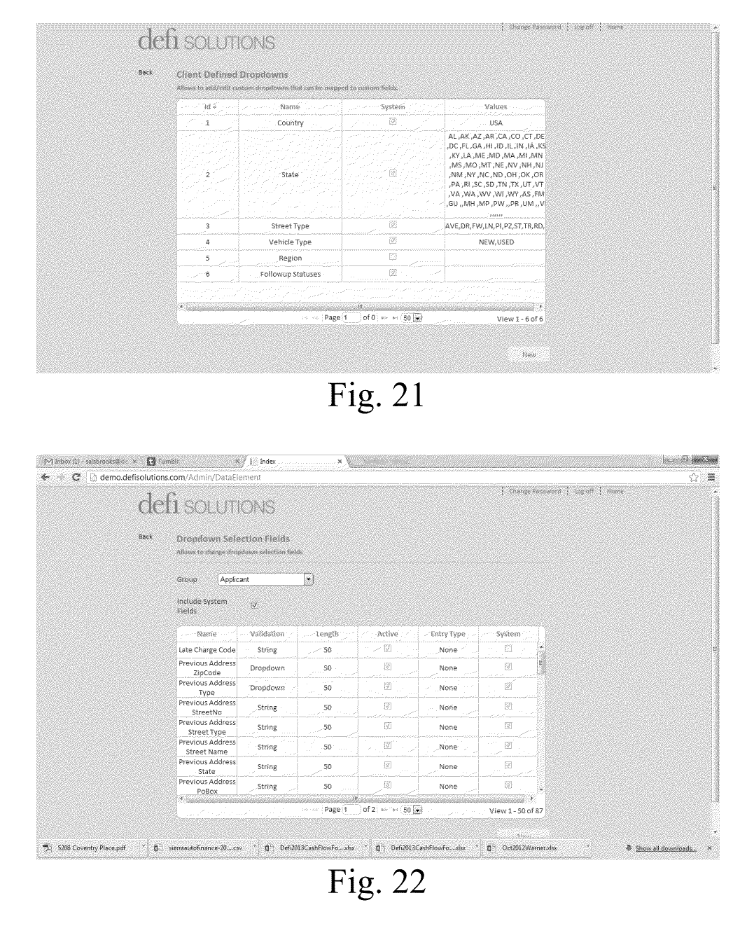

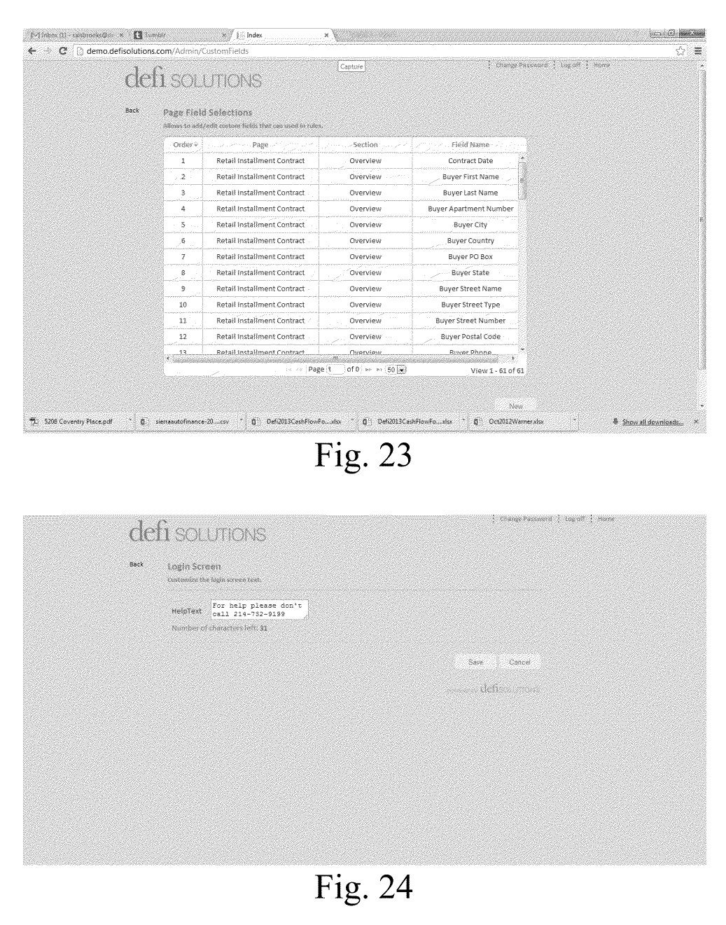

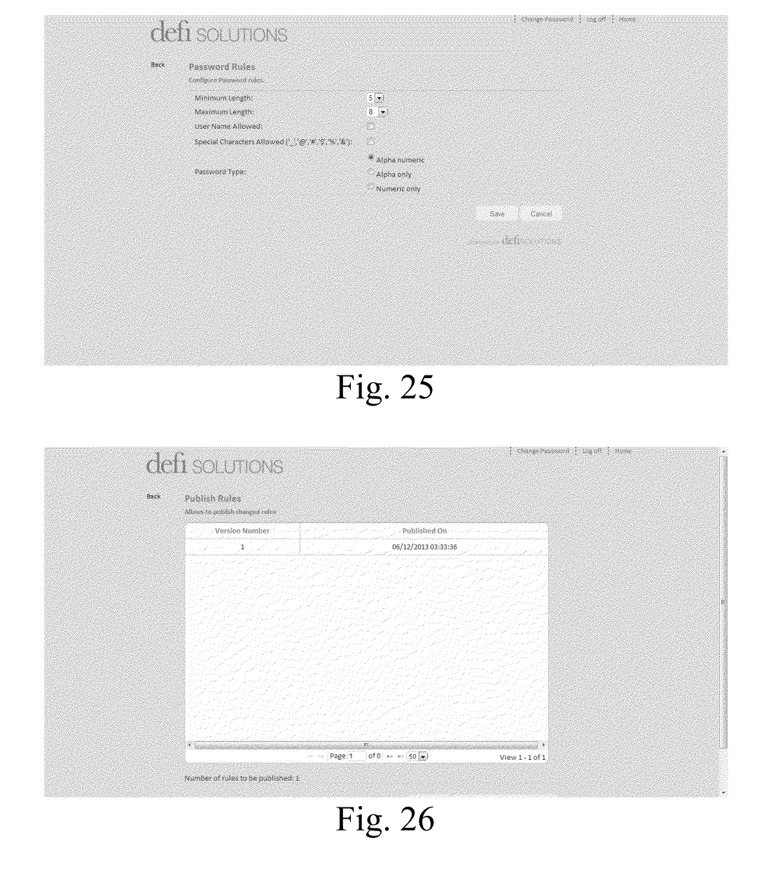

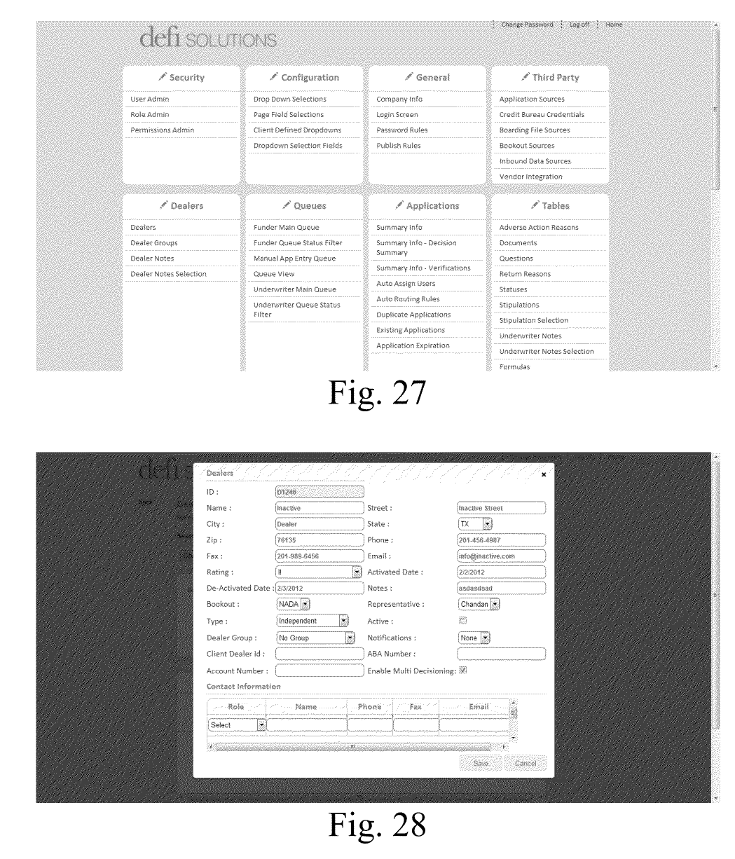

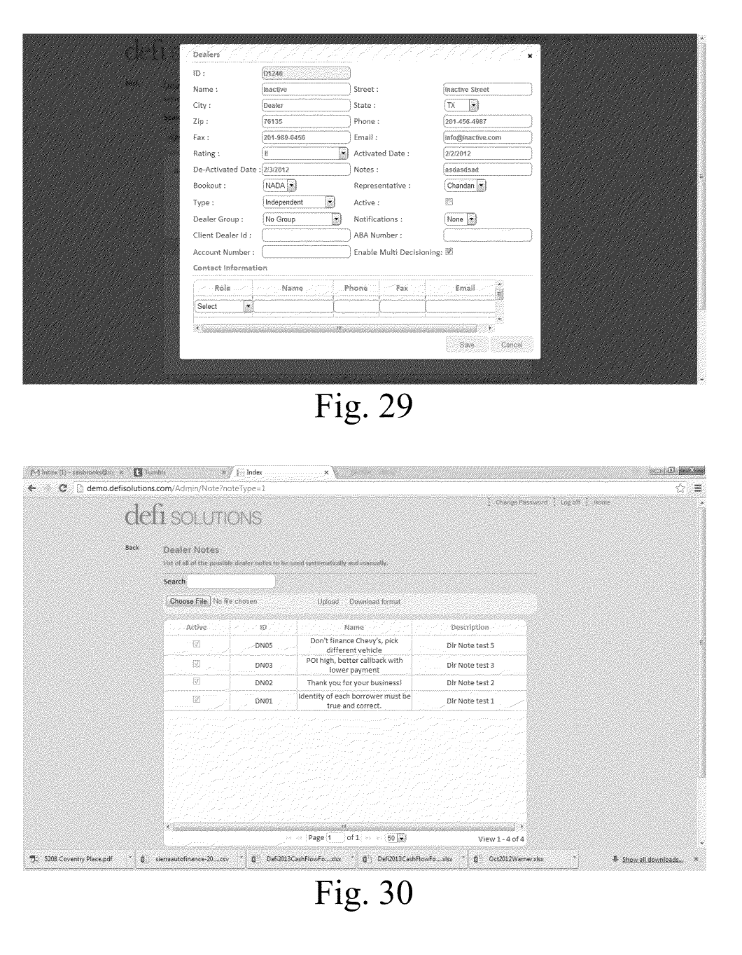

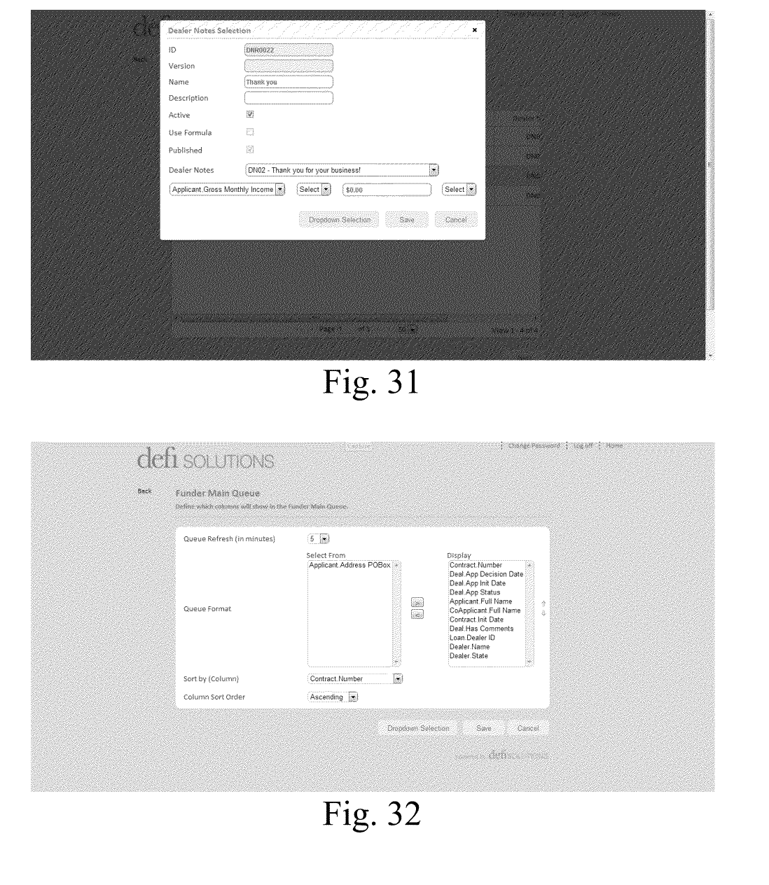

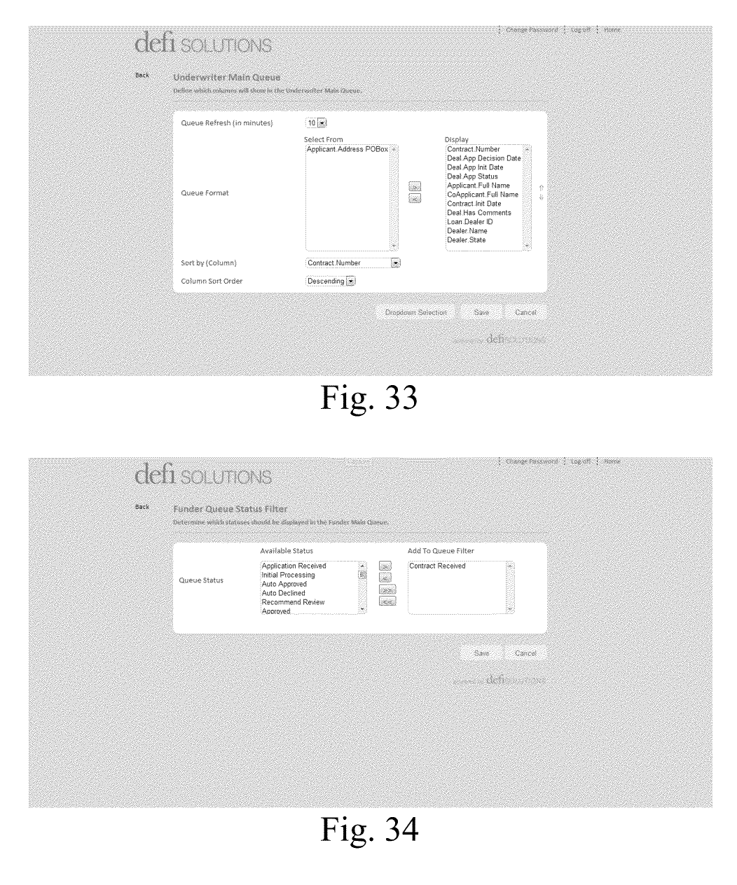

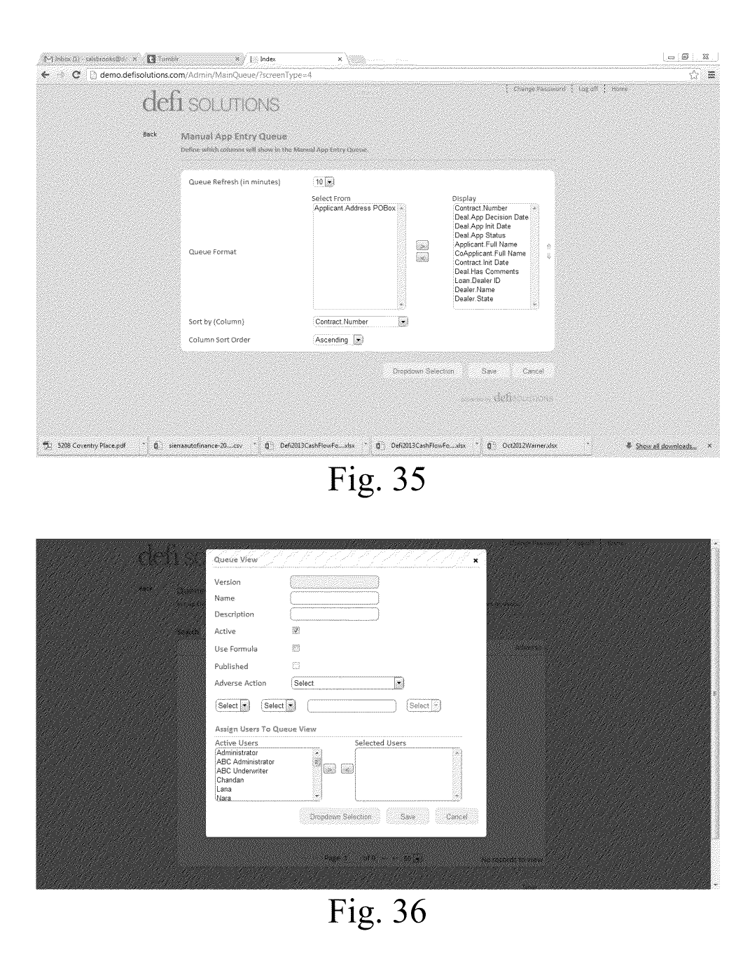

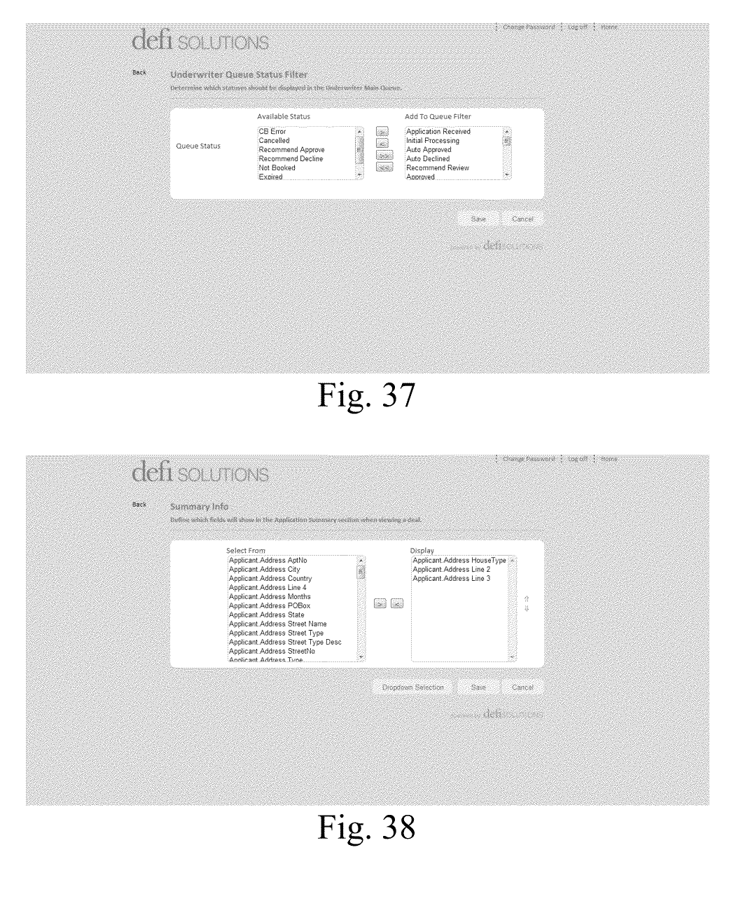

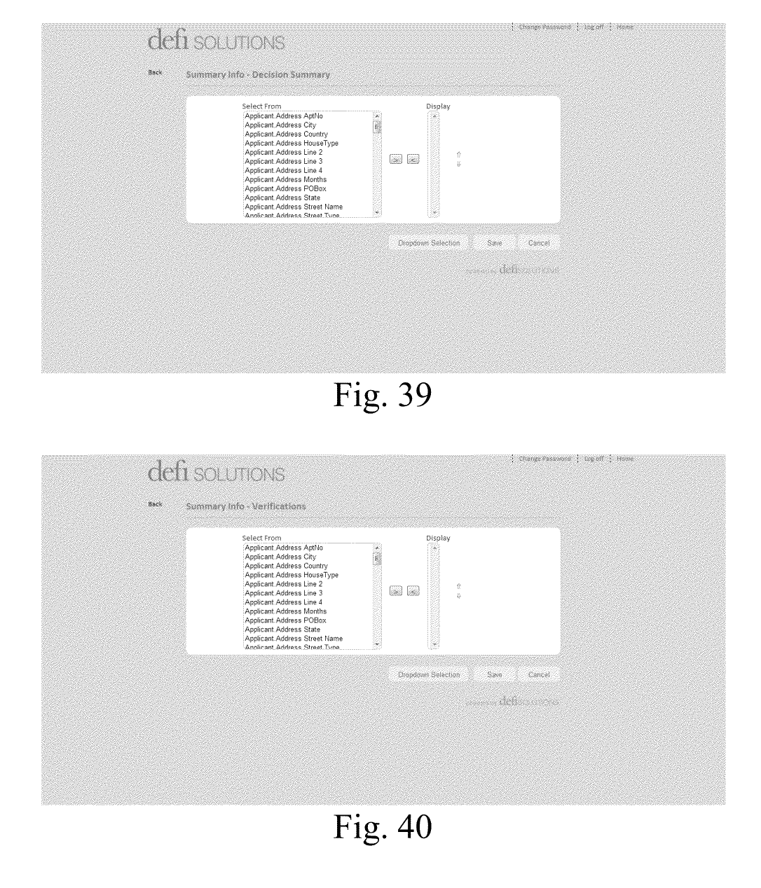

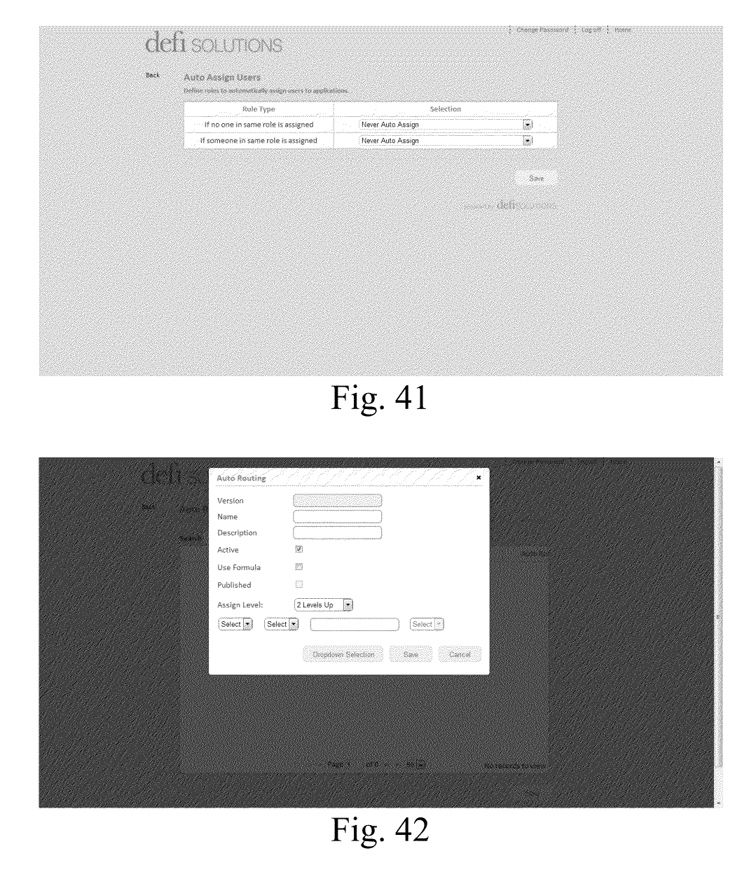

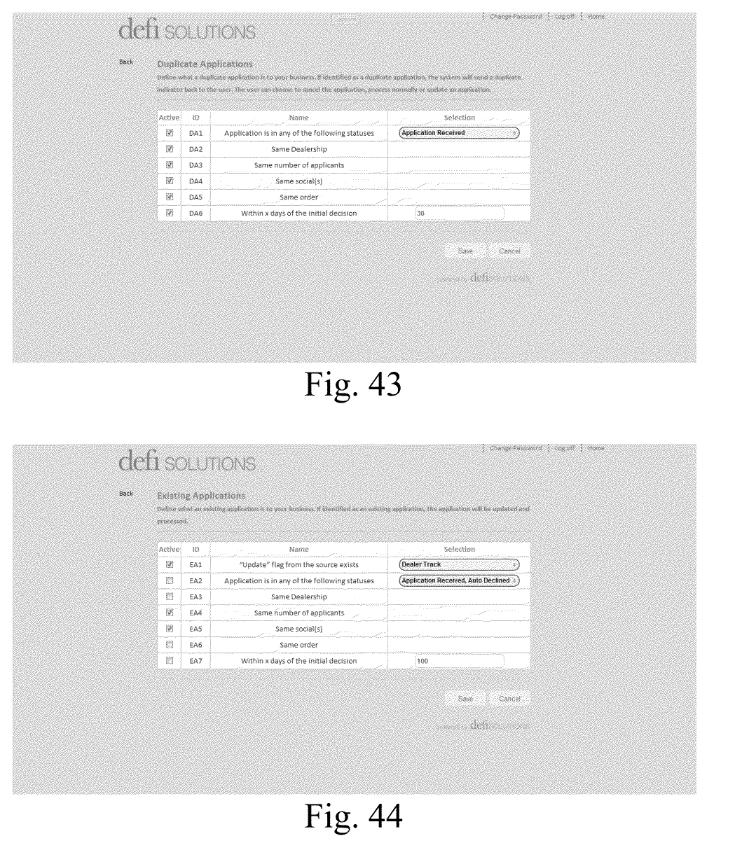

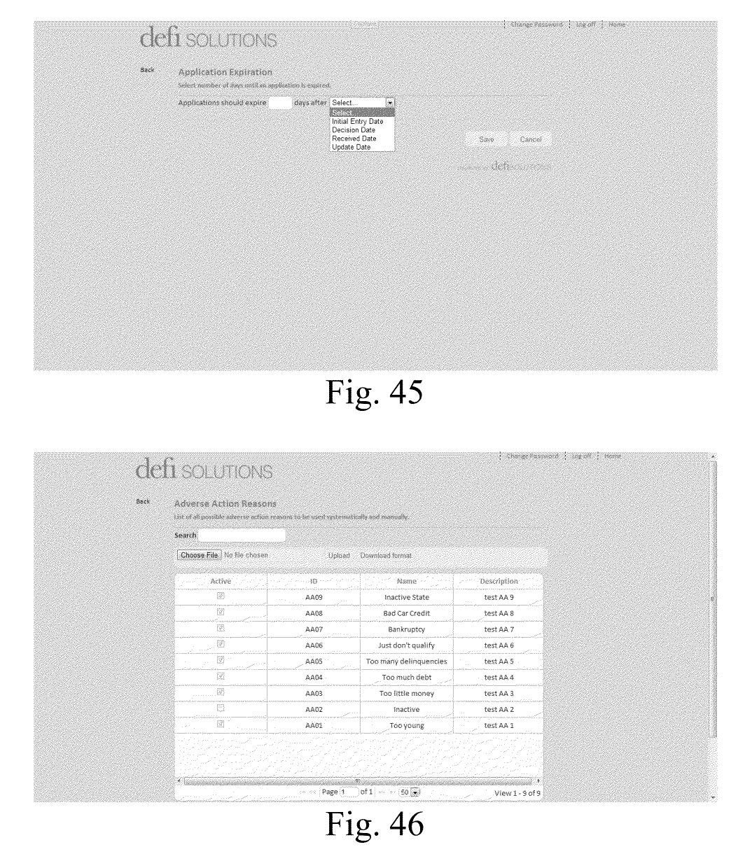

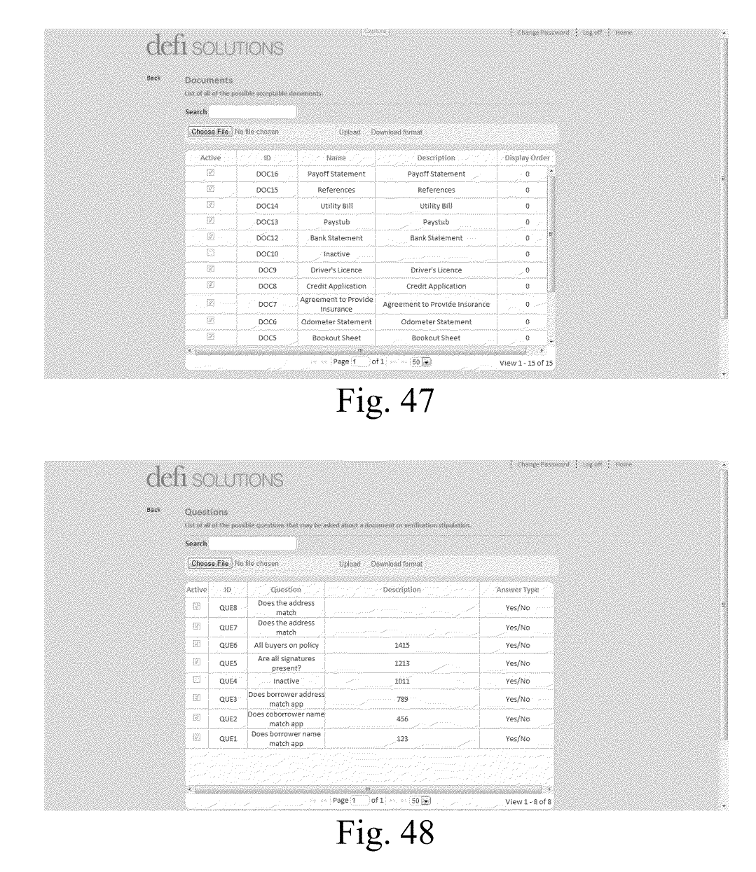

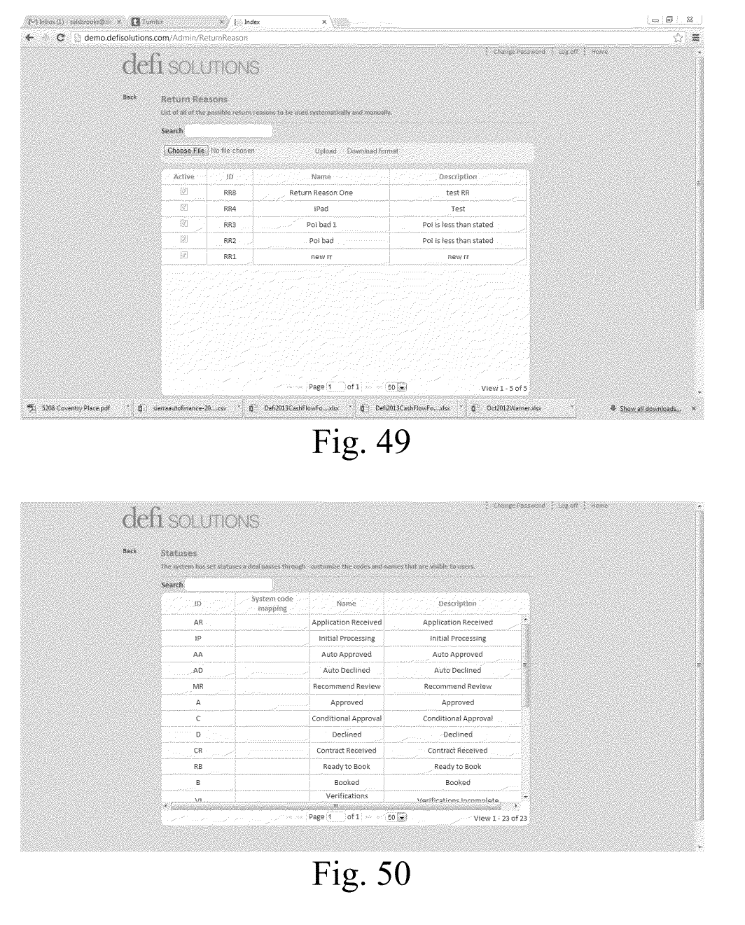

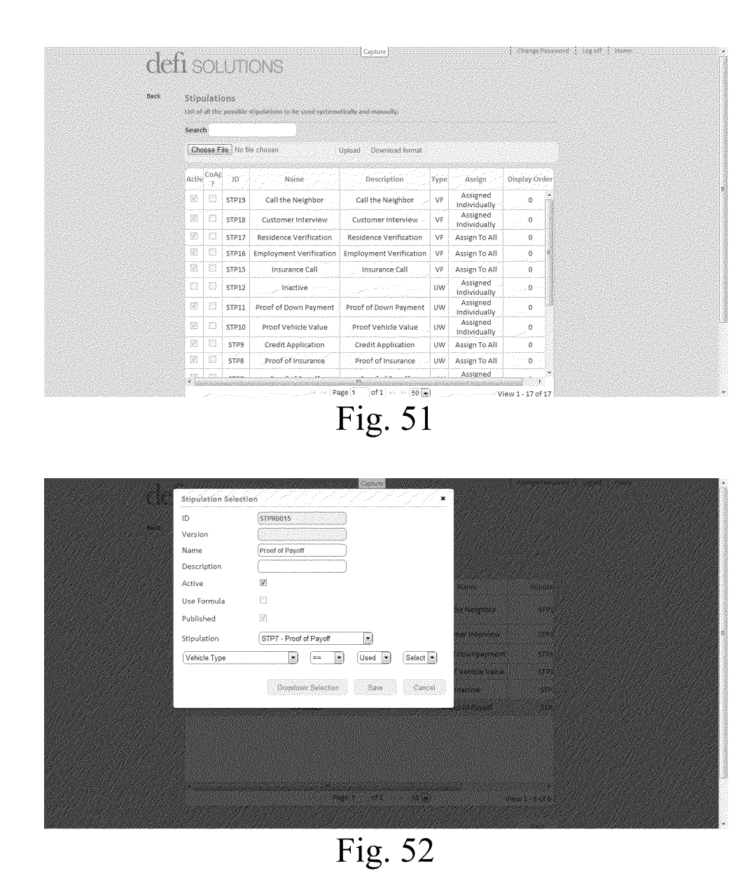

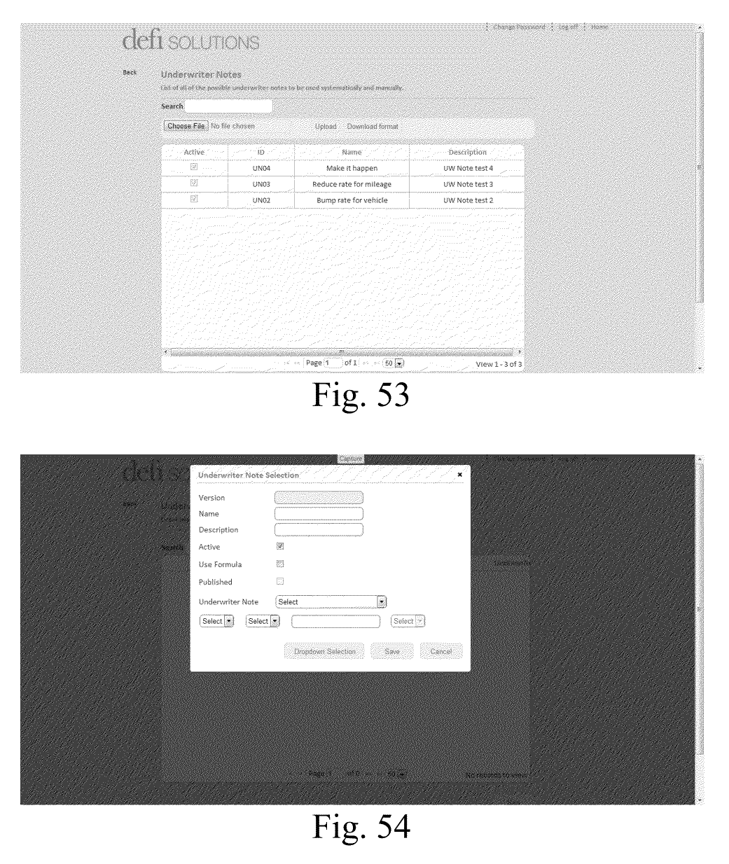

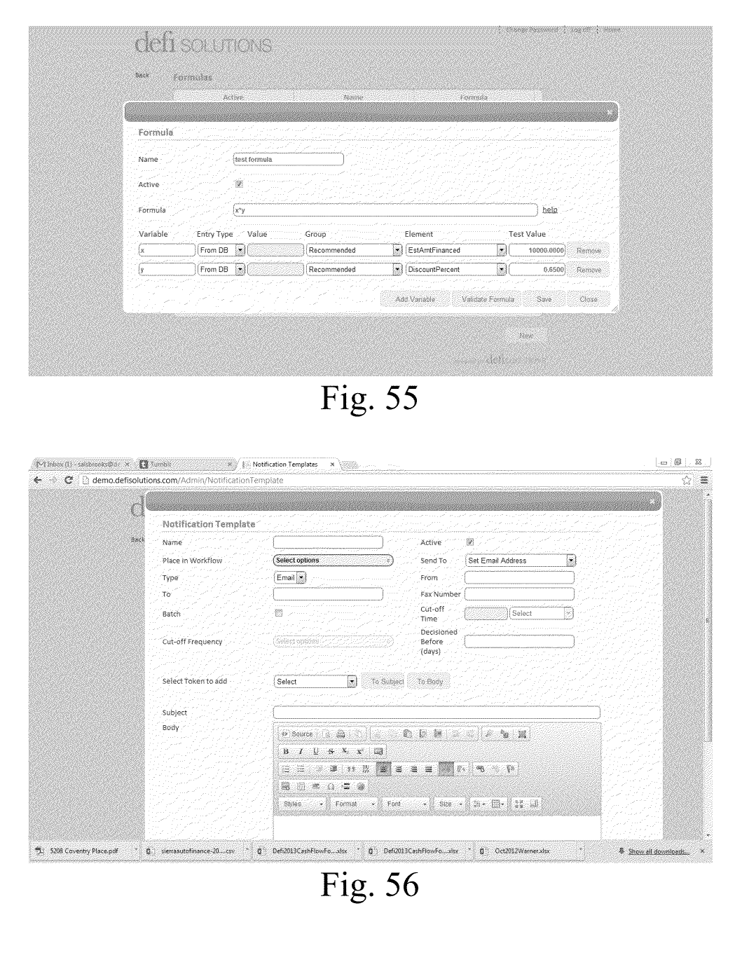

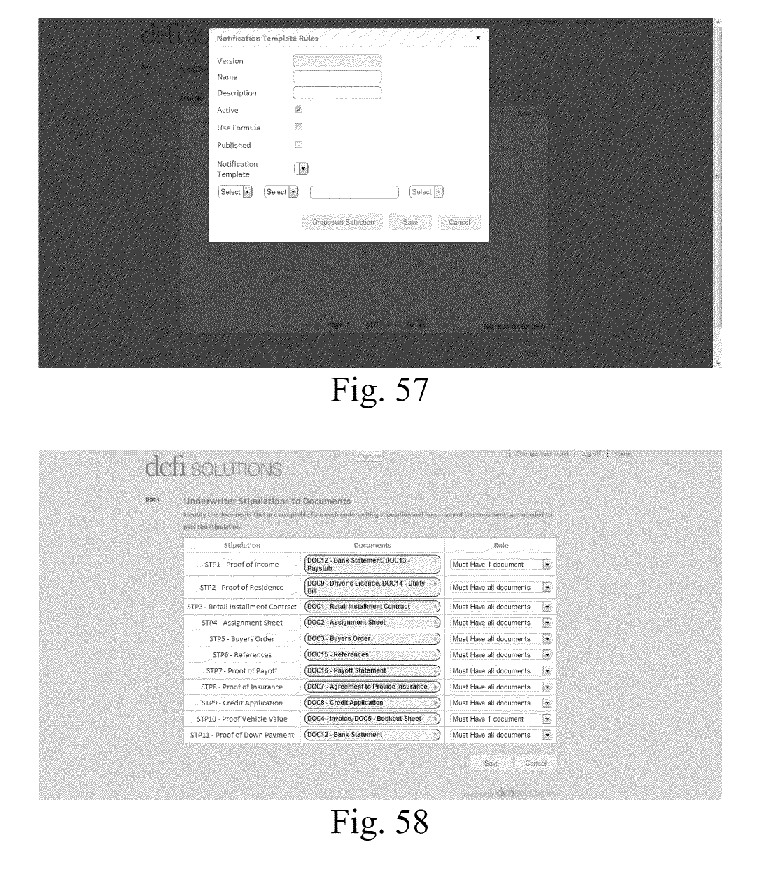

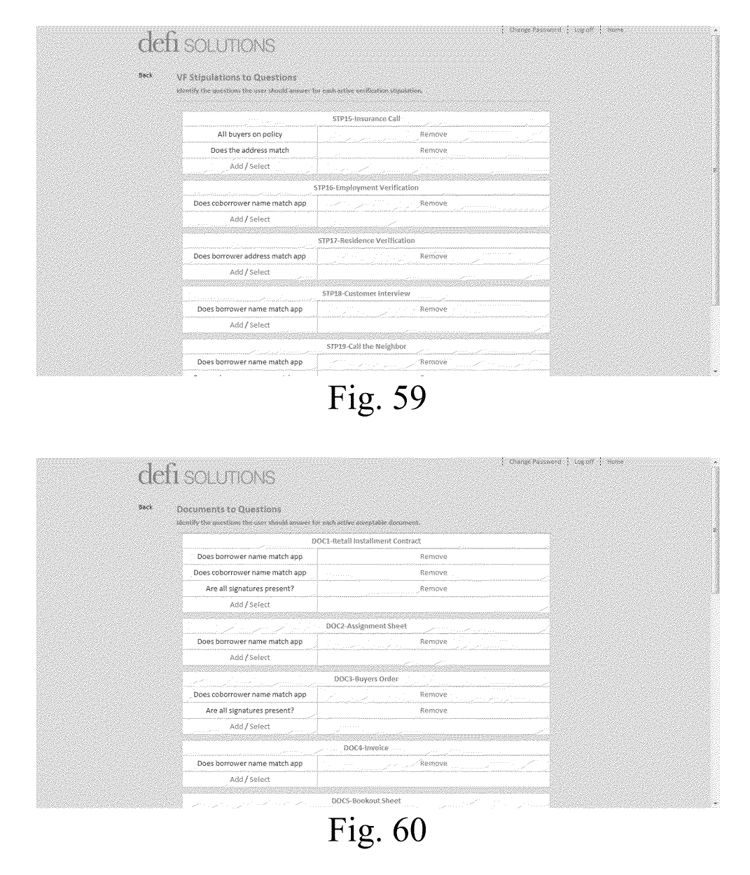

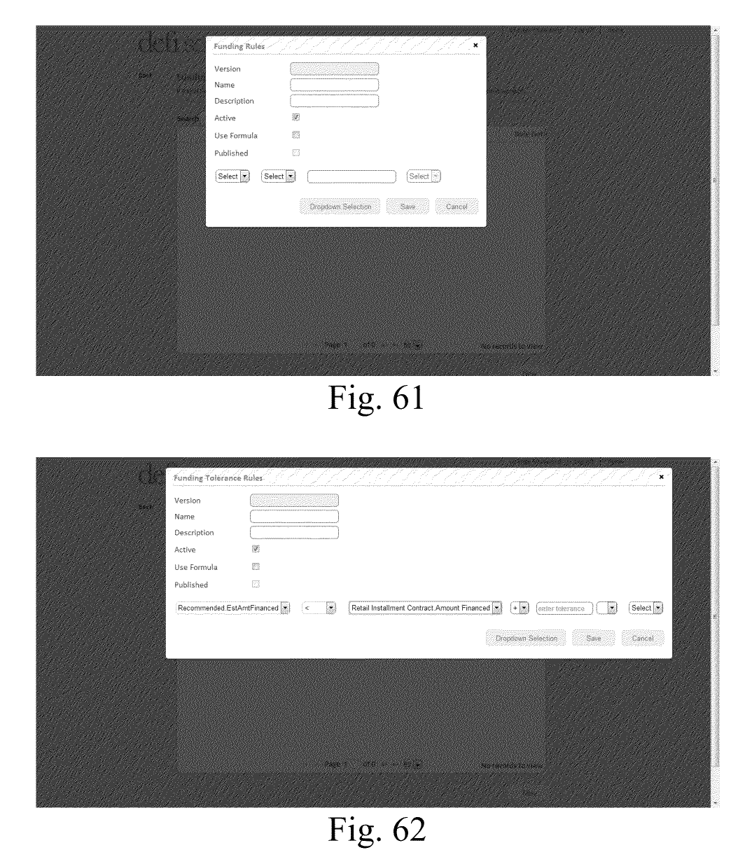

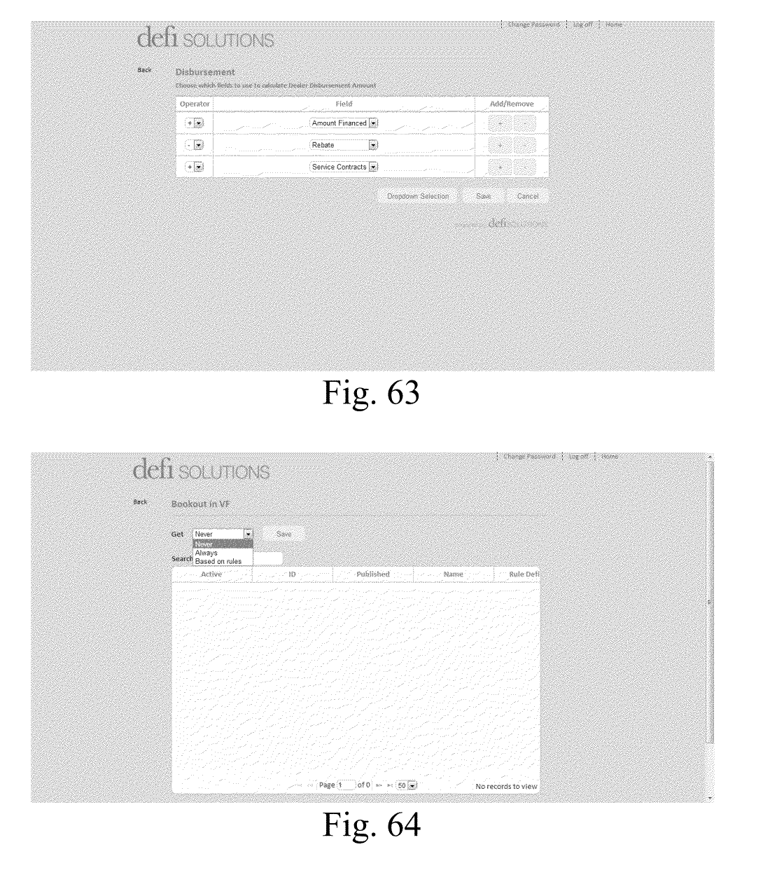

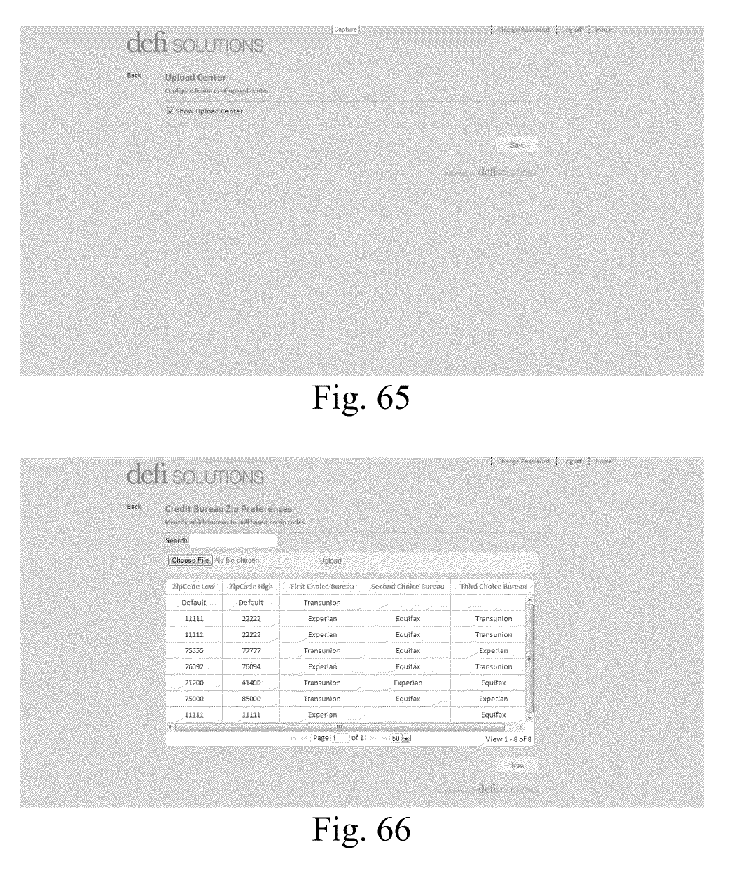

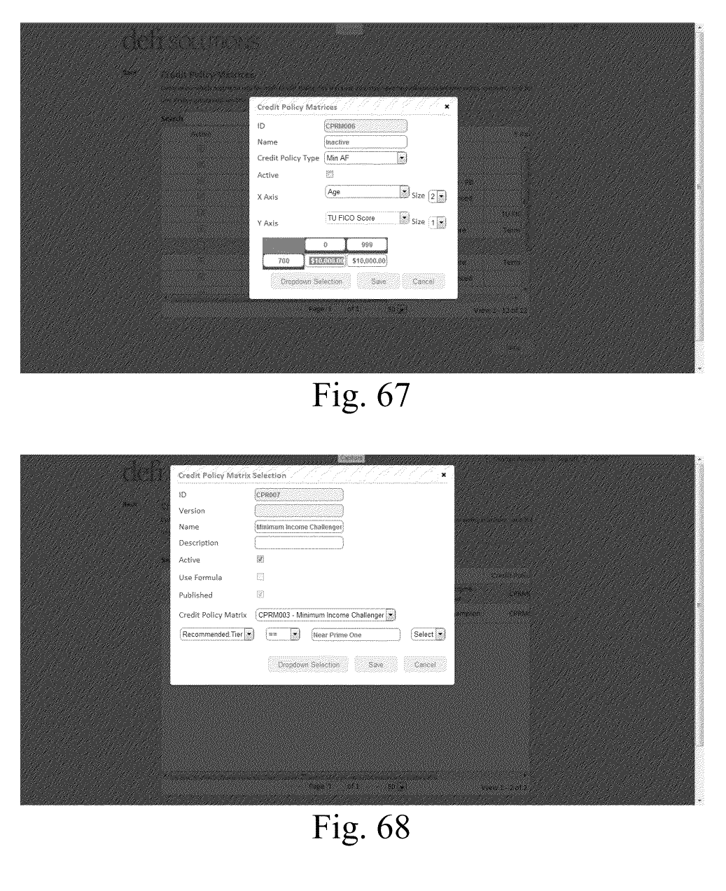

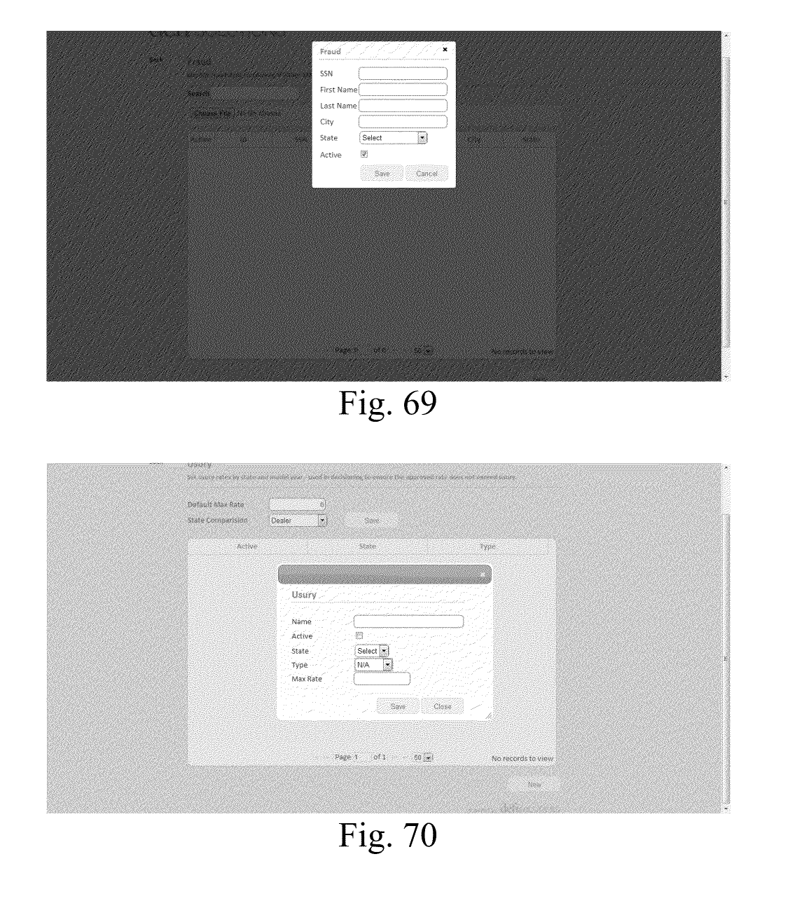

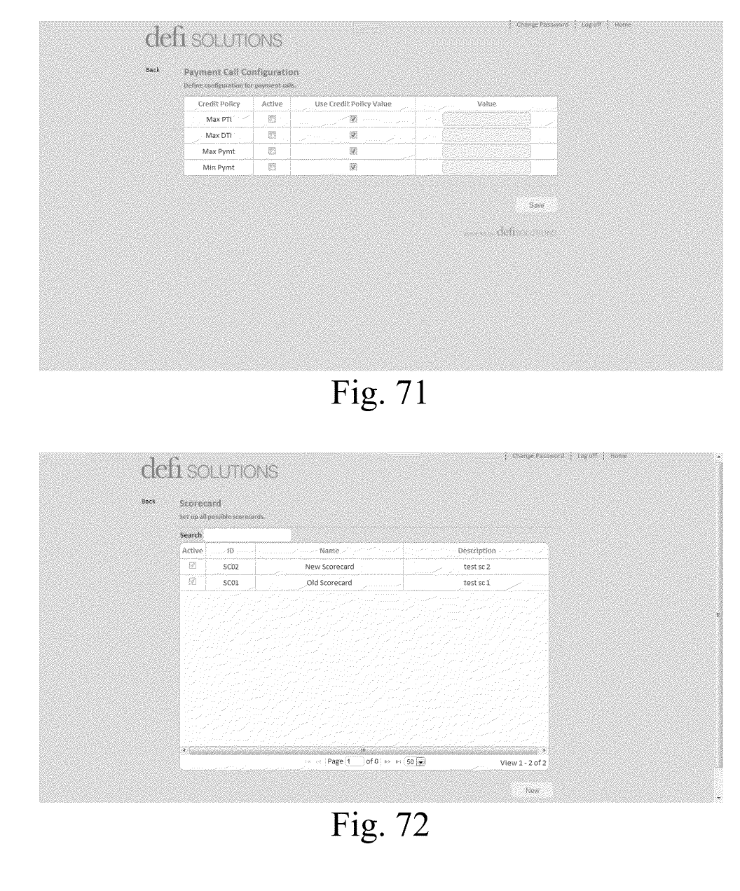

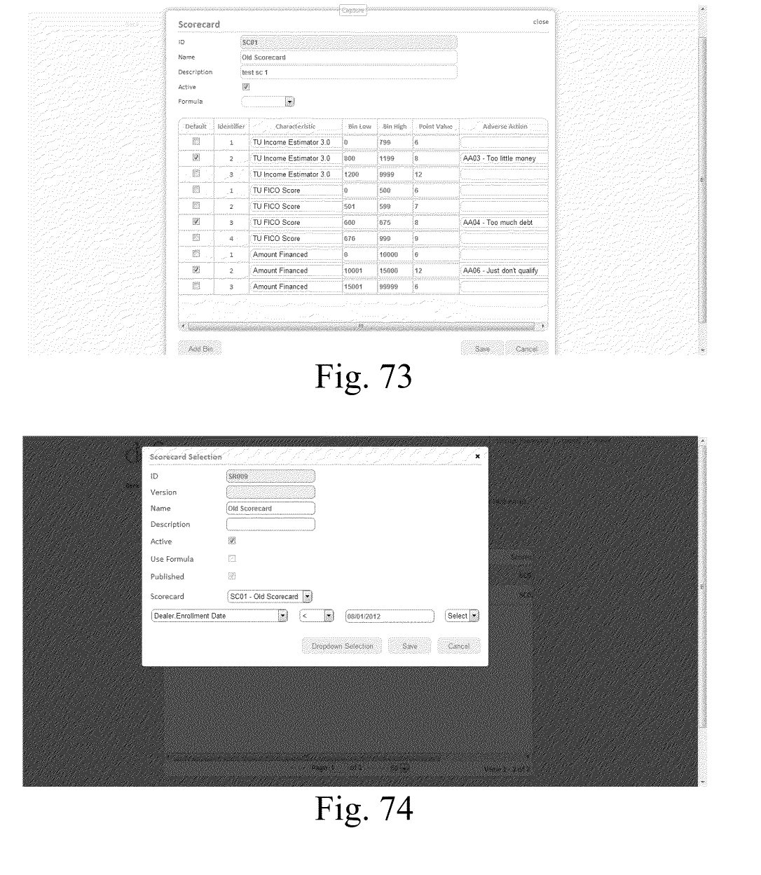

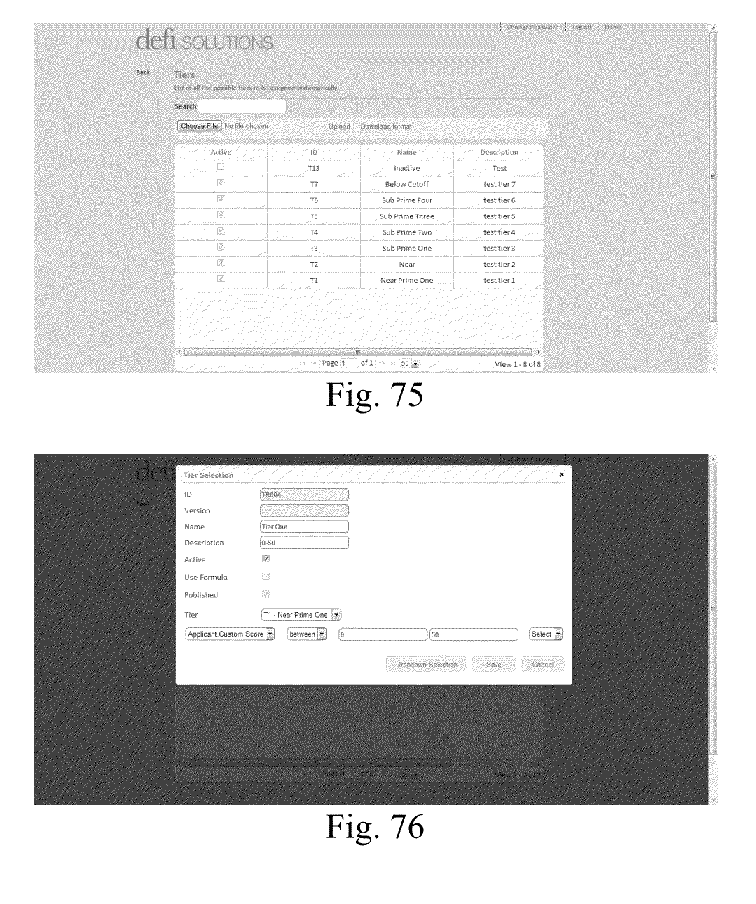

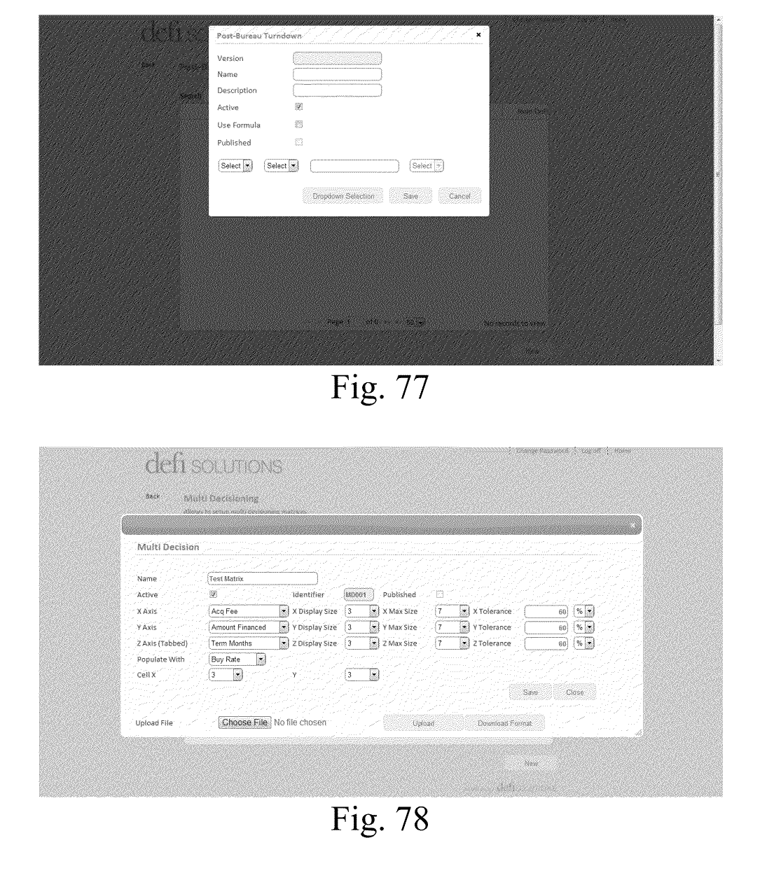

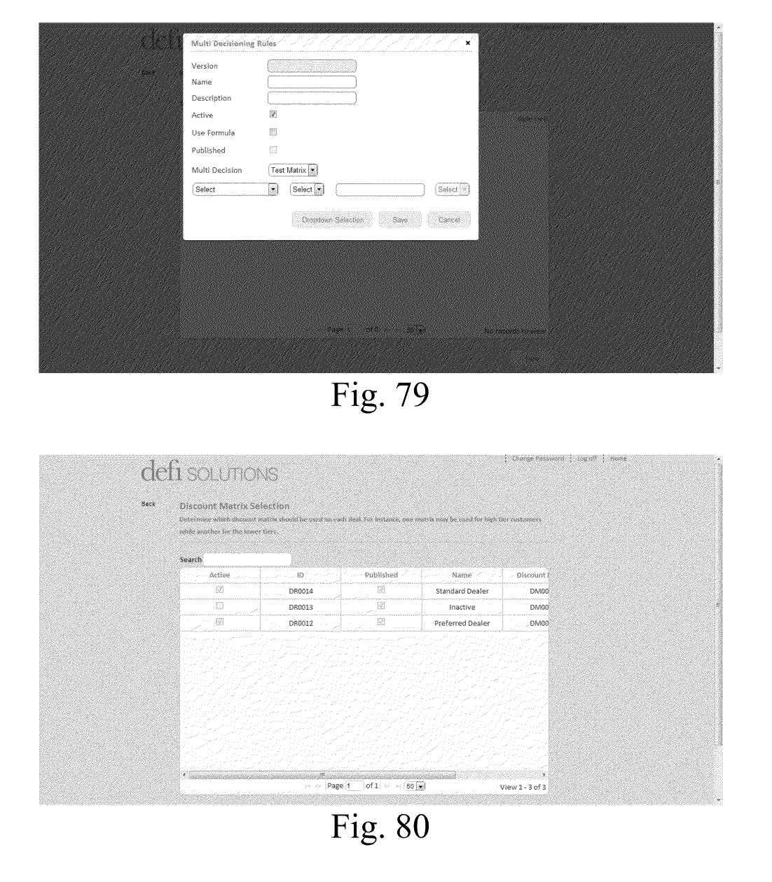

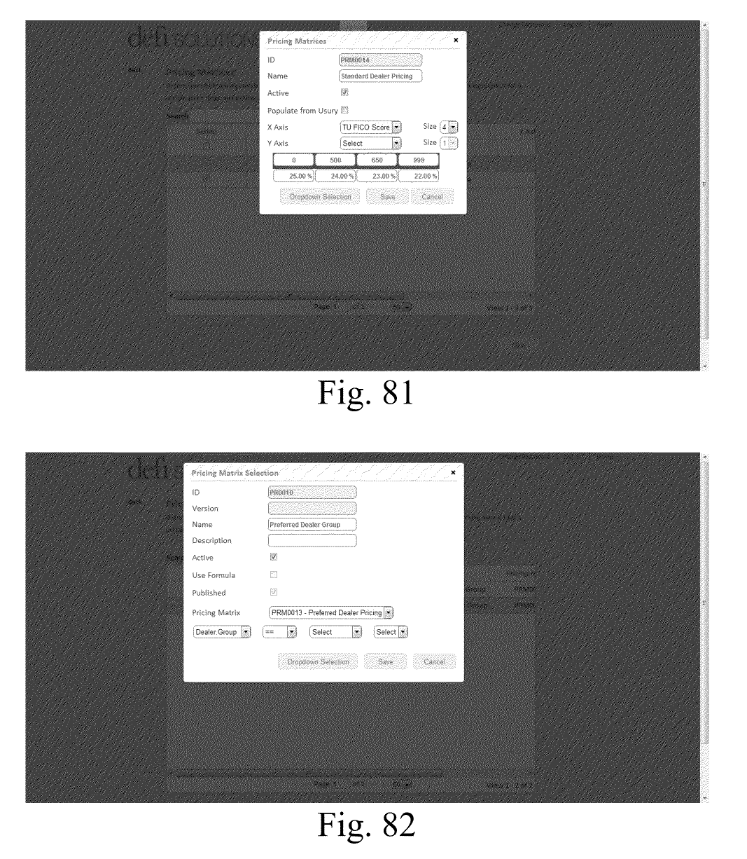

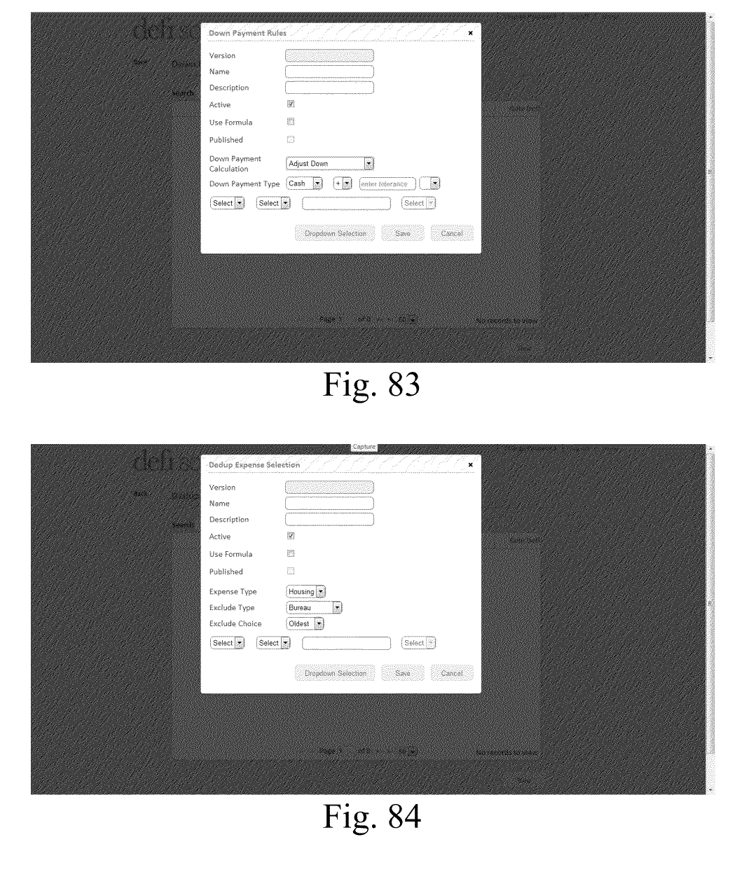

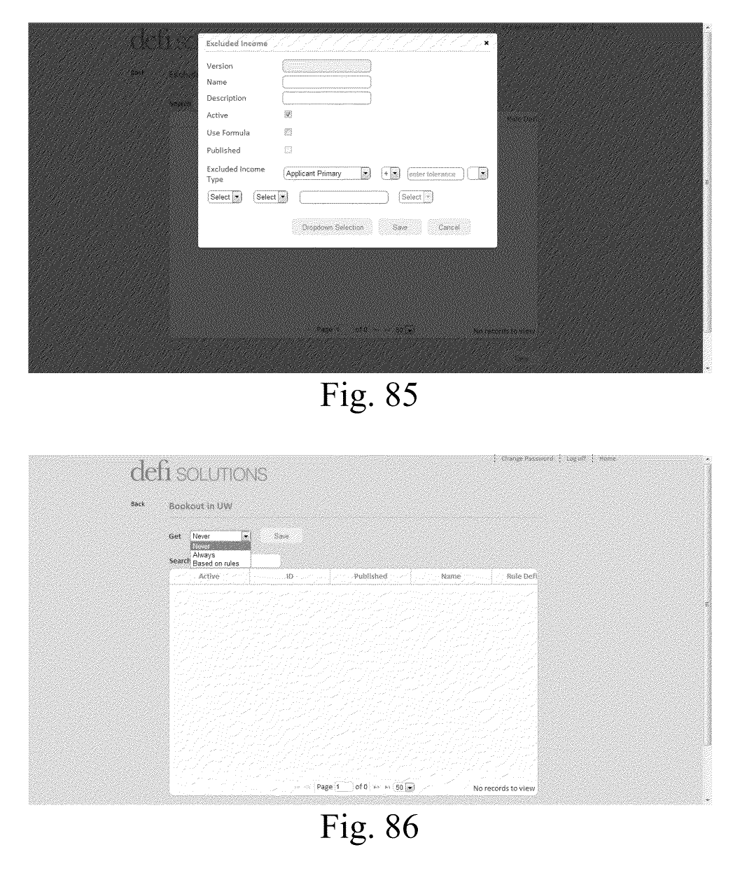

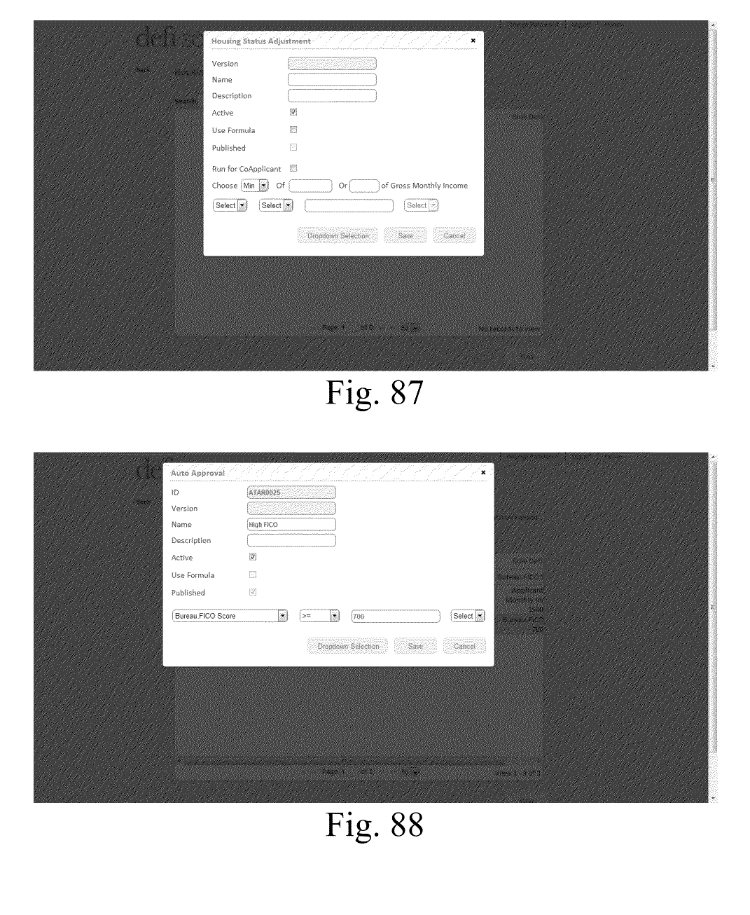

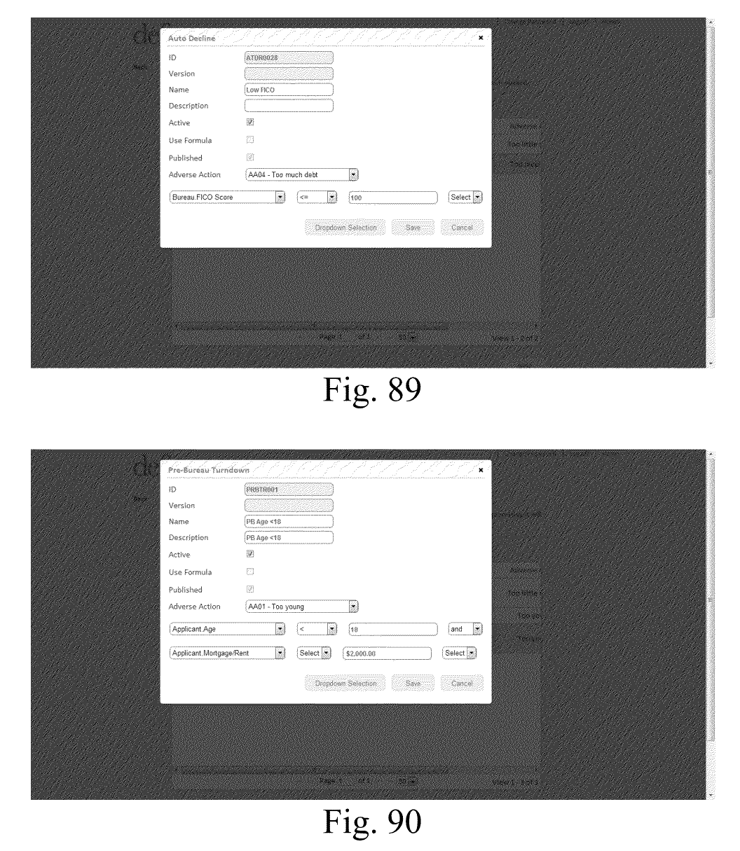

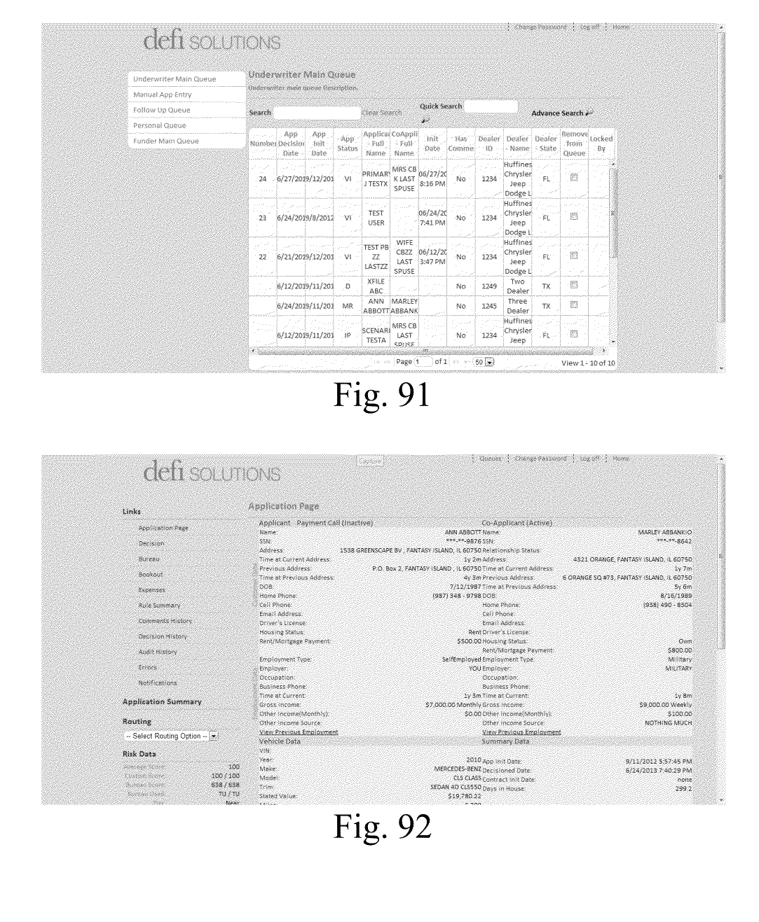

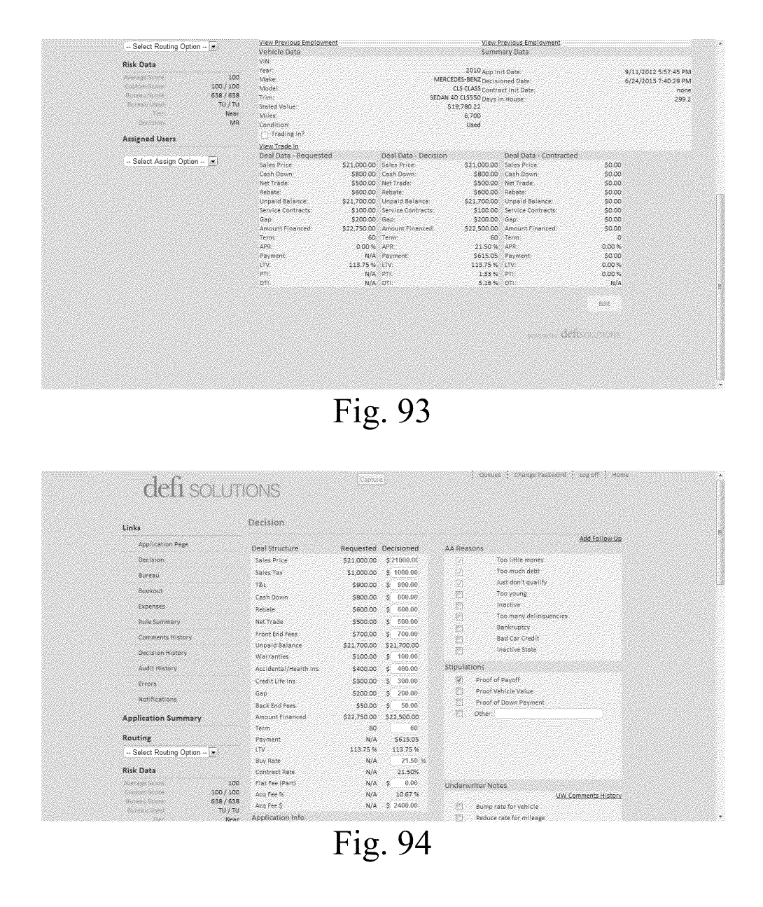

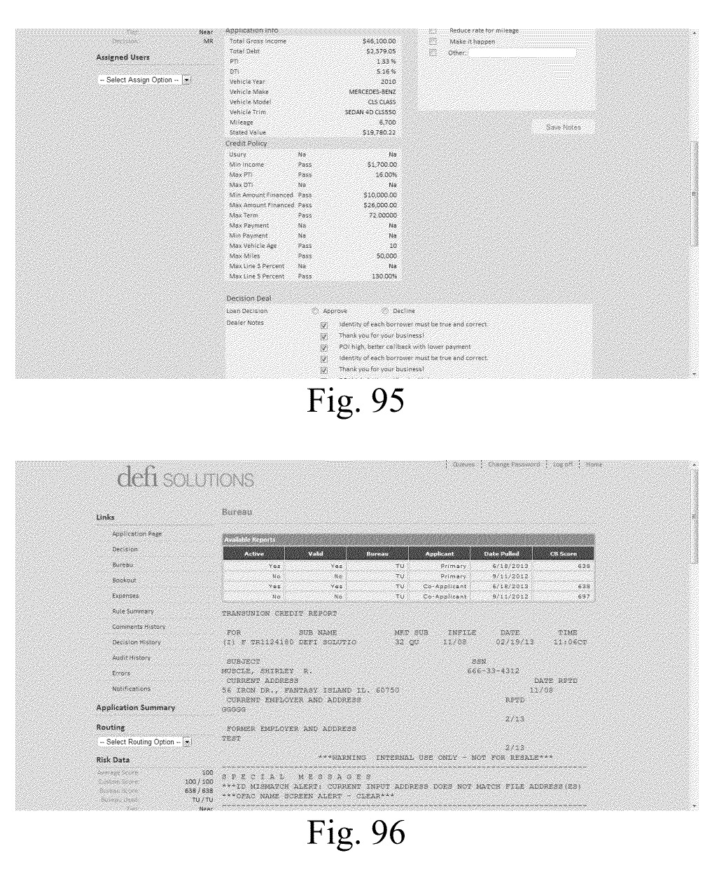

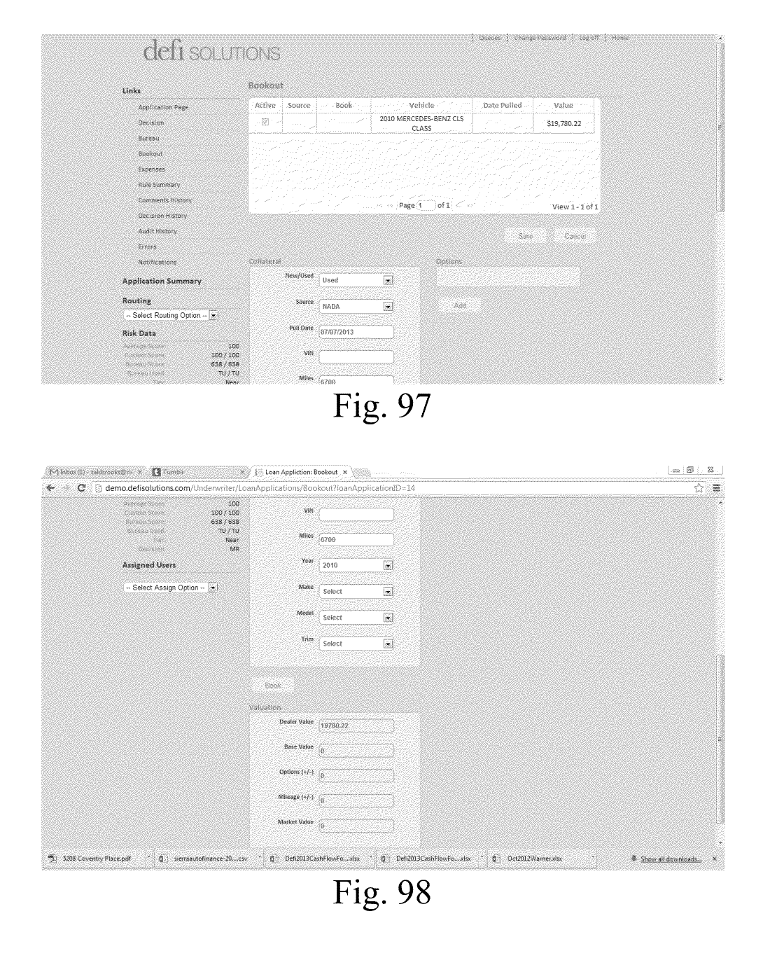

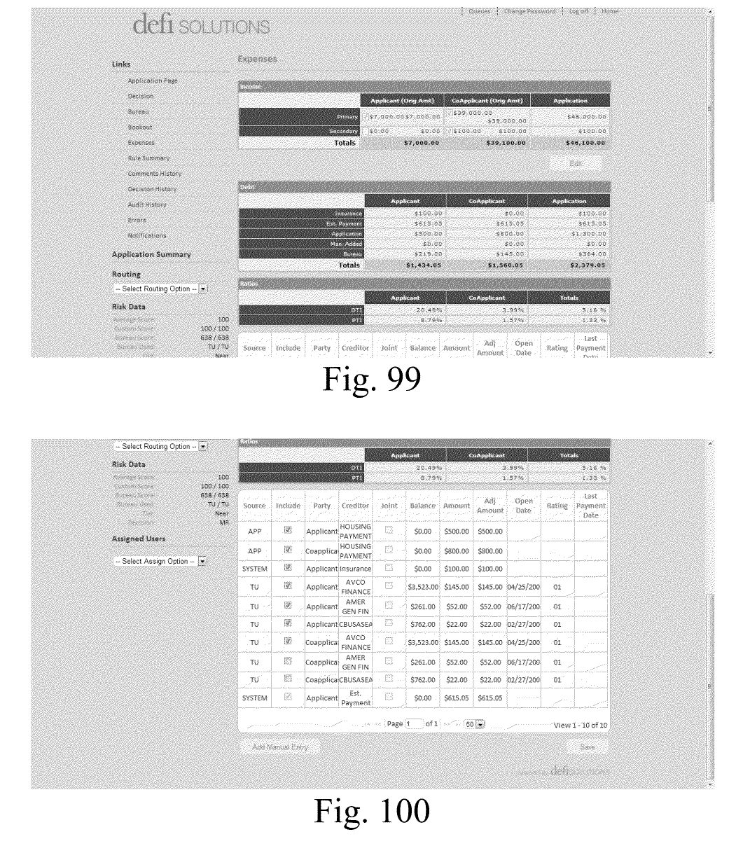

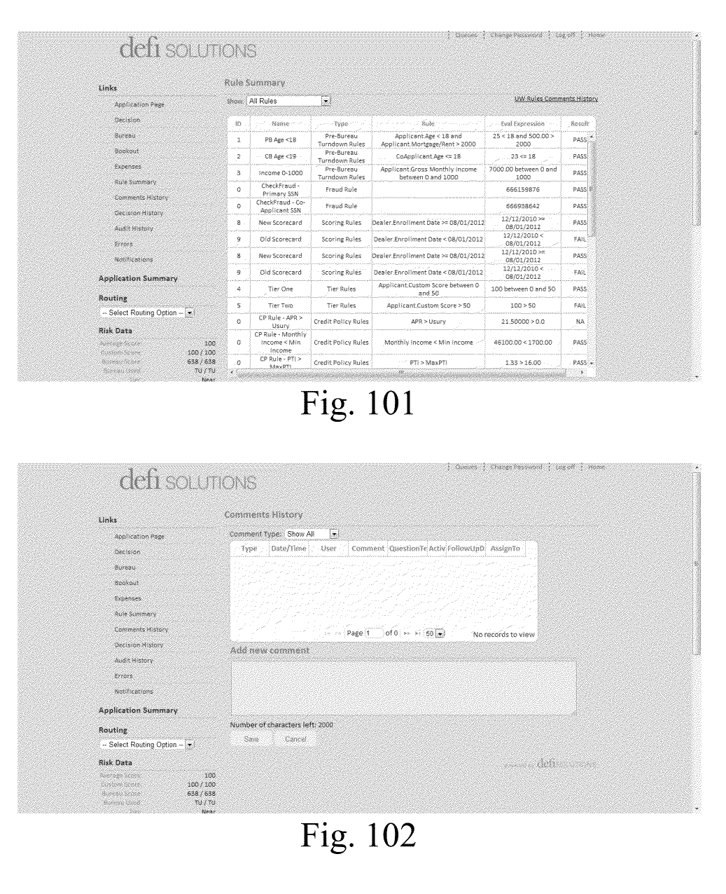

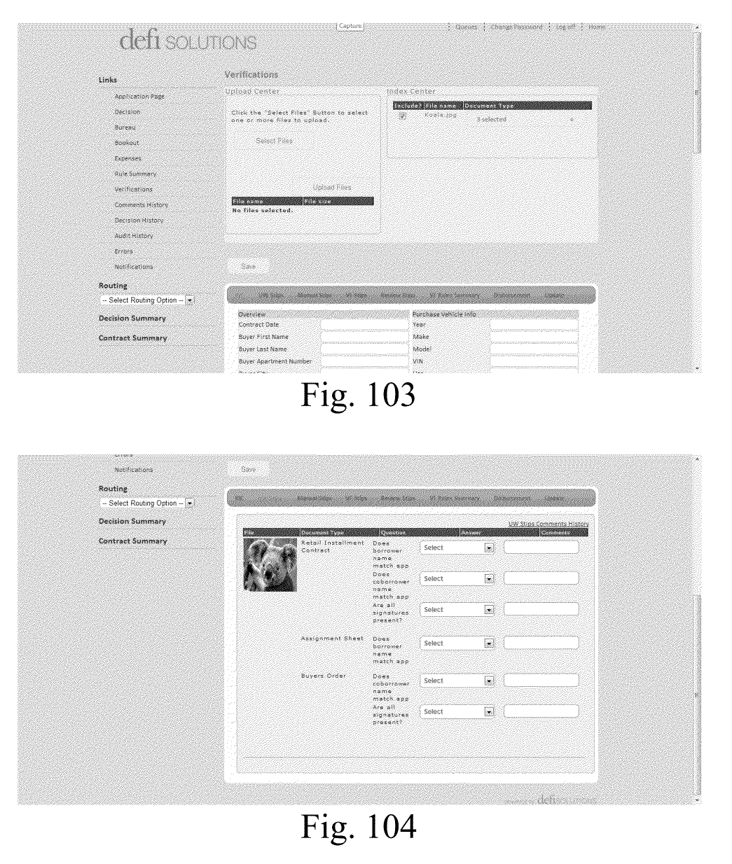

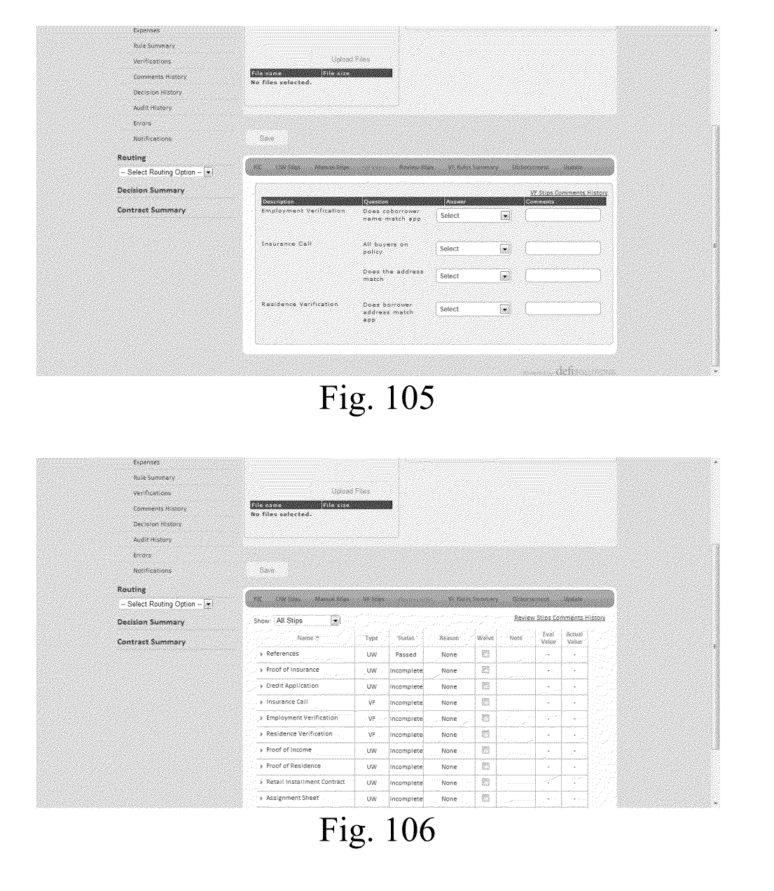

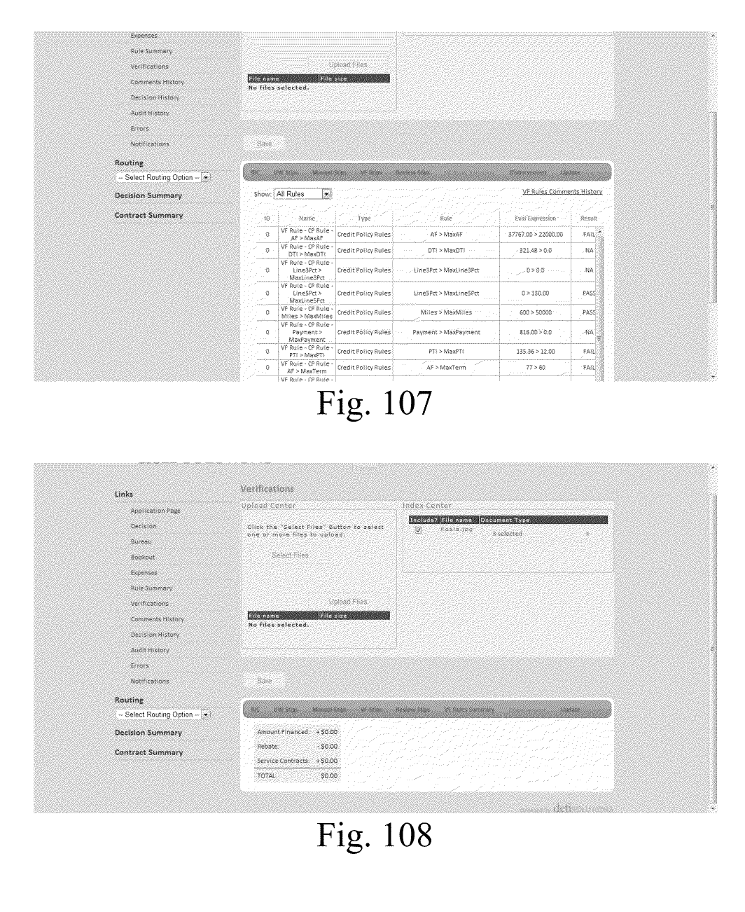

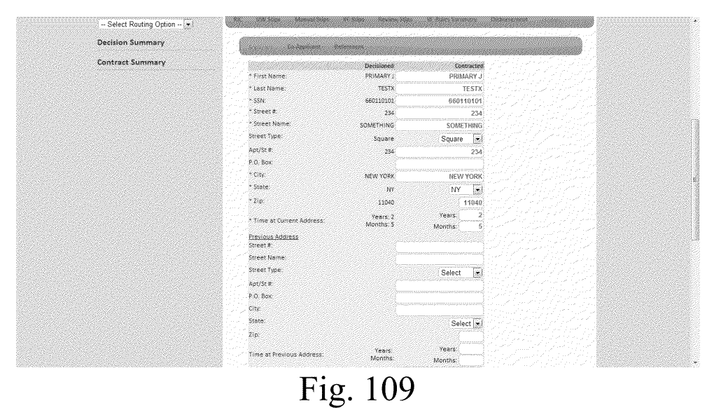

FIGS. 12 to 109 illustrate an example loan origination system according to aspects of the subject technology. The subject technology is not limited to the specifics of this example. Rather, the example is illustrated in detail in the interest of thoroughness.

FIG. 12 shows a login screen to be displayed to a lender. The logo for the login screen preferably is customizable, as is text (e.g., “For help . . . ”) that may be displayed on the login screen.

FIG. 13 illustrates a landing screen for users: A wizard may take a user through a set-up process. Configuration may be how the user maintains the system going forward. “Reports” may navigate to screens for various kinds of reports regarding approved, pending, and disapproved loans. “Queues” may be where a user goes to see deals.

FIG. 14 illustrates a starting screen for a user to enter information about a lender. FIG. 15 illustrates a “reports” configuration screen. FIGS. 16 and 17 illustrate additional configuration screens.

FIGS. 18 and 19 illustrate screens through which a user such as an administrator may various elements and/or pages view only, view and edit, or none for different users. This process can permit delegating of control to different roles and granting of granular user access.

In some aspects, users do not have to pick from a predefined list of fields to use in rules that the system uses to approve or disapprove loans. Rather, users can pick custom rules for their loan decision matrices, for example to be based upon any field in applicable databases about characteristics of potential borrower(s). FIGS. 20 to 25 illustrate examples of configuration screens that enable such customization.

FIG. 26 illustrates a configuration screen for publishing rules and/or sets of rules. As a user creates rules, the user can review the rules until the user wants to publish. Once a user publishes, the system maintains path consistency. If a rules did not exist with a particular loan application came in, the system preferably runs the rules that existed when the application came in. The system preferably does not change those rules even if new rules have been published. Applications that come in after the rules are published preferably will use the newly published rules.

The “Third Party” box in FIG. 27 permits a user to access (potentially) sensitive information about third parties. Preferably, a configuration screen is provided for a user to specify what data may be exchanged with a third party, for example via XML.

FIGS. 28 and 29 illustrates a dealer configuration screen. FIG. 30 illustrates a screen through which notifications to dealers may be set up, and FIG. 31 to 35 illustrate screens for configuring rules for displaying the notifications and/or sending the notifications to dealers.

FIG. 36 illustrates a configuration screen for setting up custom queues for loans using rules and giving permission to different users to see the various queues. FIGS. 37 to 54 illustrate various filter, summary, and other pages that preferably can be adjusted directly on those pages.

FIG. 55 illustrates a configuration page through with a user may build their own custom formula for use in rules and other aspects of the subject technology.

FIGS. 56 and 57 illustrate a configuration page through which a user may set up notifications. For example, notifications may be configured to be sent in a particular fashion such as facsimile or email, and when to send notifications may also be configured.

FIGS. 58 to 60 illustrate screens through which a user may configure requests for additional information to qualify an approved loan. After setting up possible stipulations and documents, a user preferably can tie them together so the system can determine whether a deal ultimately passes or fails.

FIGS. 61 and 62 illustrate screens through which a user may set up funding rules and funding tolerance rules for the system to run to determine if a deal should pass or fail. Users may desire to set up payment policies, formulas for payments to dealers, credit policies, and the like. Figs. FIG. 63 to 71 illustrate various screens through which a user may take these actions in the example loan origination system.

FIG. 72 to 90 illustrates configuration screens through which a user may build “scorecards,” for example to track dealer performance. FIGS. 91 to 100 illustrate “user” screens, for example through which a user may configure information about a lender. The user screens preferably are fully customizable by the user, for example in terms of layout and the information entered through those screens.

FIGS. 101 and 102 illustrate screens through which a user may see “behind the scenes” calculations and operations. Again, these screens preferably are fully configurable by the user. However, in preferred embodiments, the “behind the scenes” information may be provided in default formats. FIGS. 103 to 109 illustrate additional miscellaneous configuration screens for the example loan origination system.

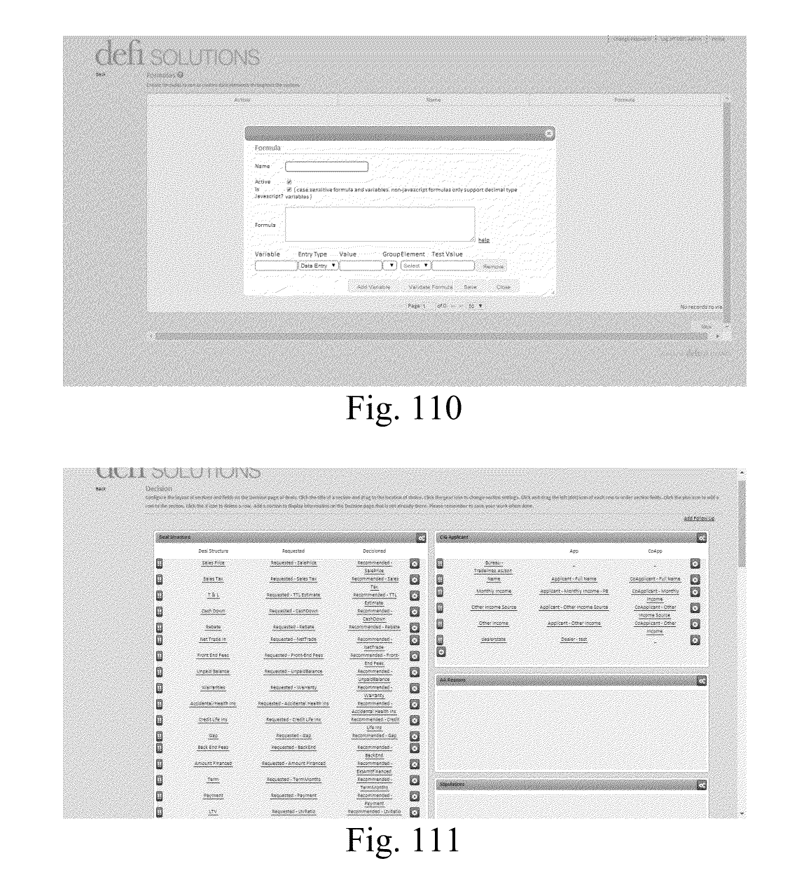

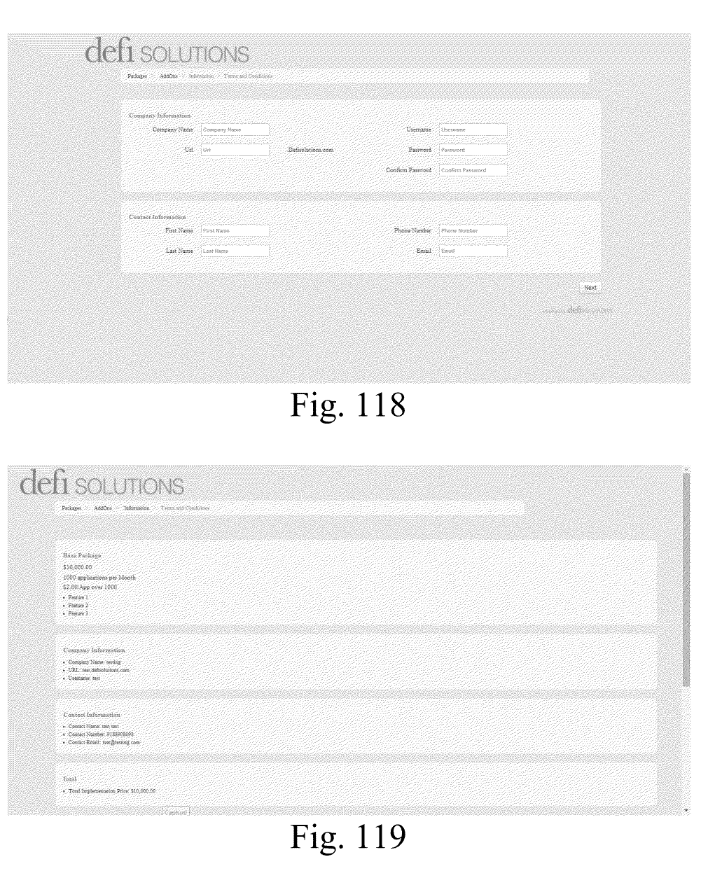

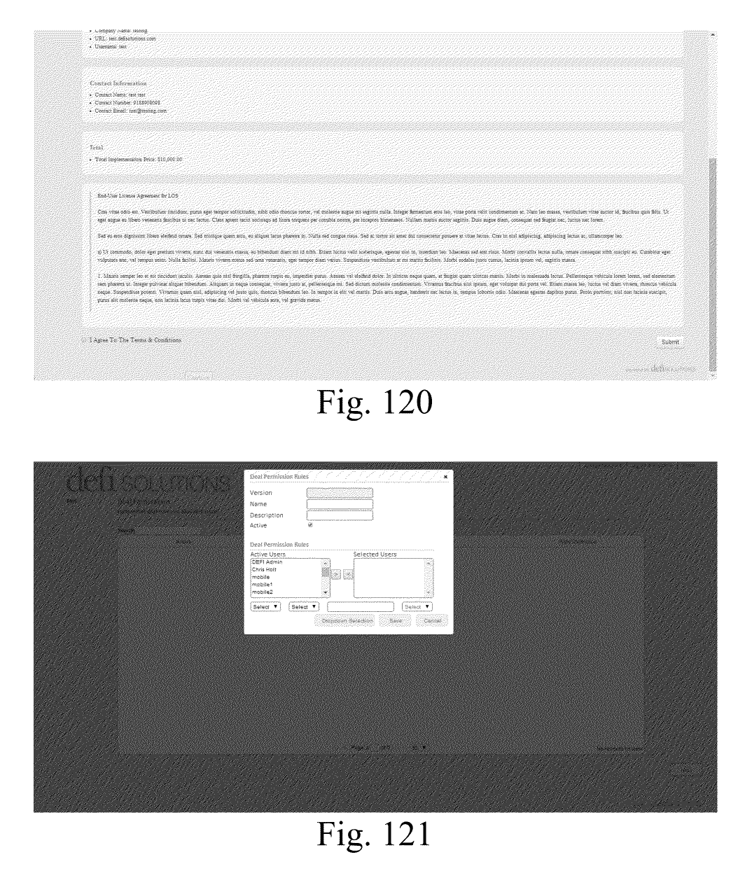

FIGS. 110 to 130 illustrate details of further possible functionality of an example loan origination system according to aspects of the subject technology. The subject technology is not limited to the specific details of the example screens, but rather encompasses the techniques and principals enabled by the screens. In some aspects, the users of these screens are people at a lender. However, in other aspects, some screens may also be used by dealers in some instances.

FIG. 111 illustrates a screen for building formulas, for example for matrix rules, using a programing language such as JavaScript. This feature enables even greater flexibility, for example allowing user to set up Excel type formulas, looping through bureaus, and the like.

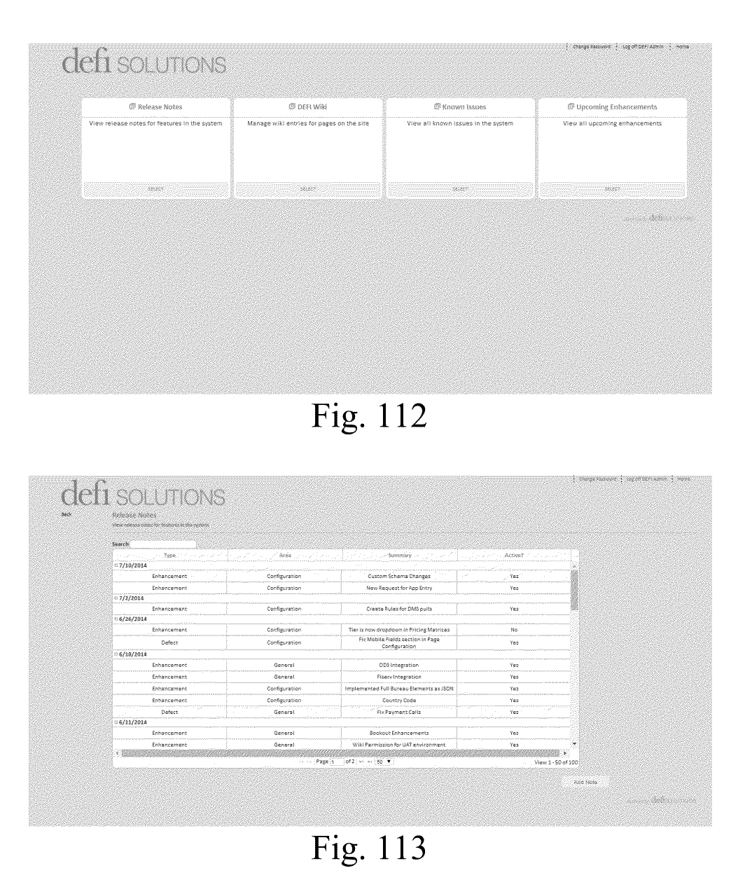

FIG. 112 illustrates configuration screens through which a user may control the user interface of user pages. In some aspects, a user is provided a starting template, and the user can then move sections around, add/delete sections and/or fields, change names, change fields, etc.

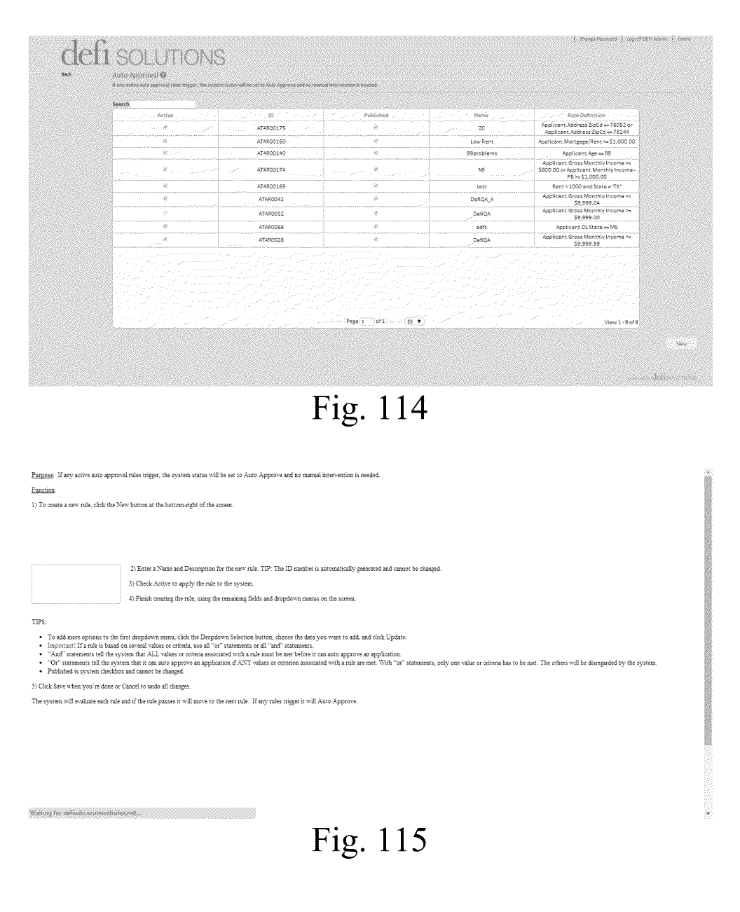

FIGS. 113 and 114 illustrate screens through which a customer portal may be accessed. At the portal, users may see relevant information such as see release notes, enter tickets/production issues, view known defects and upcoming enhancements, and the like.

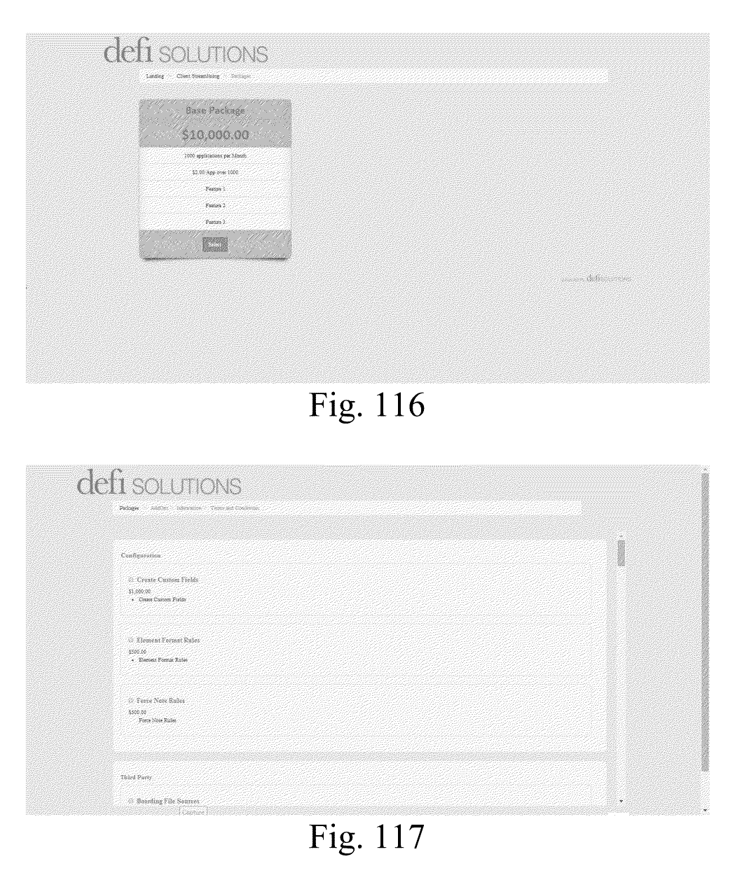

FIG. 115 illustrates that a Wiki or other knowledge sharing tool may be built into some or all of the screens. Access to the Wiki in FIG. 115 is through a “?” button. FIG. 116 illustrates an example of a Wiki page accessed in this manner.

In some aspects, certain types of users have similar needs. Thus, some of the customization enabled by aspects of the subject technology may be performed ahead of delivery to a user. FIG. 117 to 120 illustrates screens for selecting a pre-customized loan origination package and providing information for populating portions of the package. A user may add desired add-ons, make desired further customization, and then proceed. This process may streamline use of a customizable loan origination system according to aspects of the subject technology.

FIG. 121 illustrates a dealer permission screen. This screen may allow a user to set rules as to when dealers (or other users) can see loan deals. For instance, user 1 may only be able to see and search for applications related to branch 1, while user 2 can see everything.

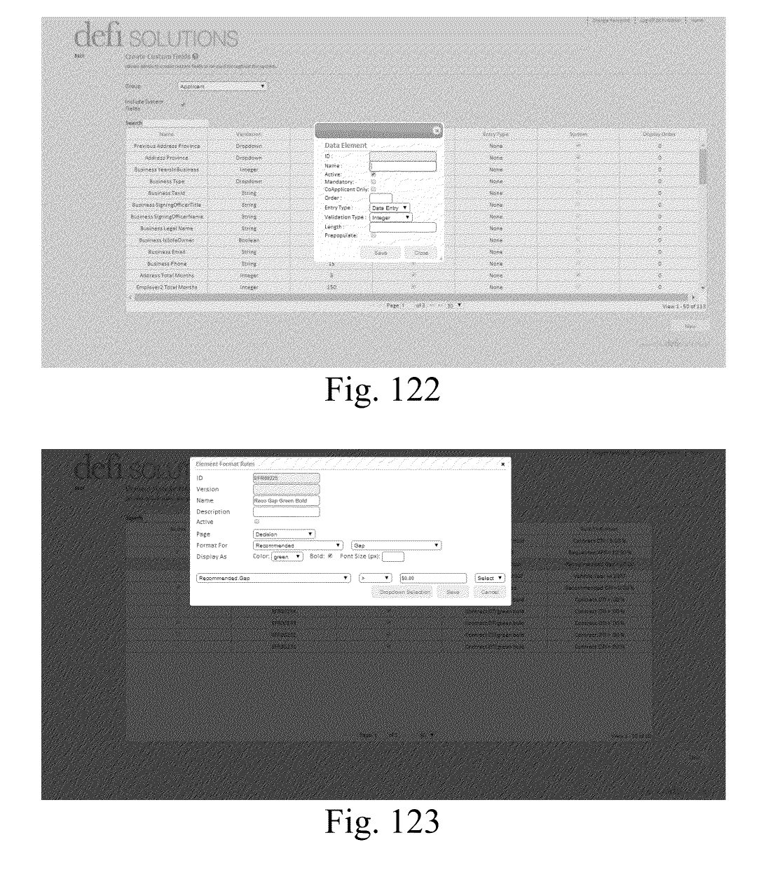

FIG. 122 illustrates a screen through which users may add new and/or custom fields to their database, preferably instantly. Fields may contain information from data entry, dropdown, formula, or some other source. Fields may be prepopulated with a value or from another field.

FIG. 123 illustrates a screen for element format rules. Through this screen, a user may change the colors, size, font characteristics, and the like of fields on pages based on rules.

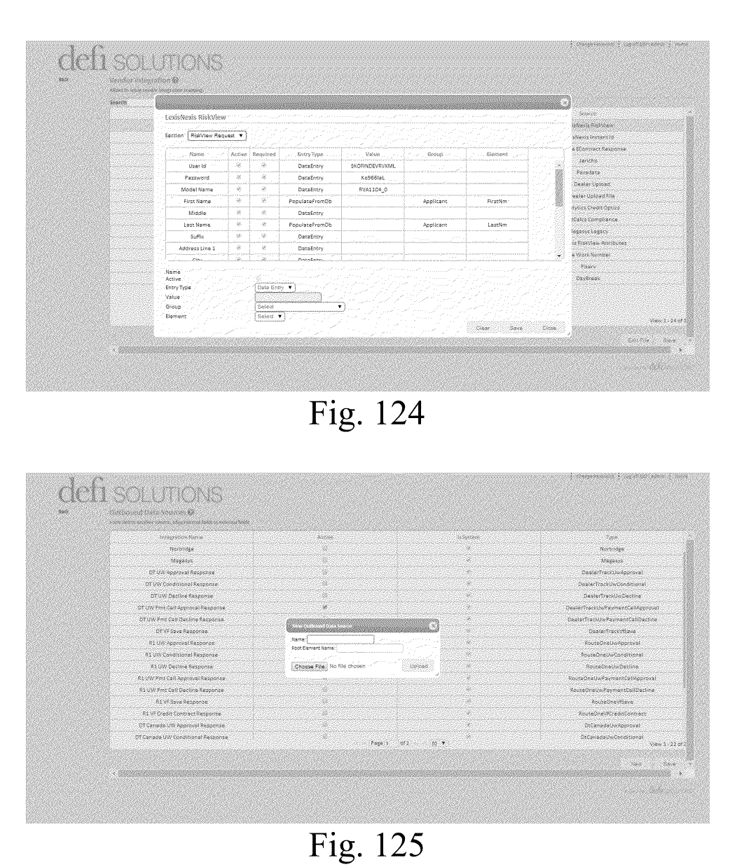

FIG. 124 illustrates a screen for vendor integration. Through this screen, a user may integrate with third party vendors, preferably seamlessly. Preferably, the user can map what fields to send the vendor. For example, XML for communication with vendors preferably is located in a configuration page that the user may set-up and/or modify.

Some inbound/outbound traffic from the loan origination system may be pre-configured. However, a user preferably may upload their own inbound/outbound XML requests and tell the loan origination system when to run them and how to map the fields via business configuration pages. An example of a screen for performing this process is illustrated in FIG. 125.

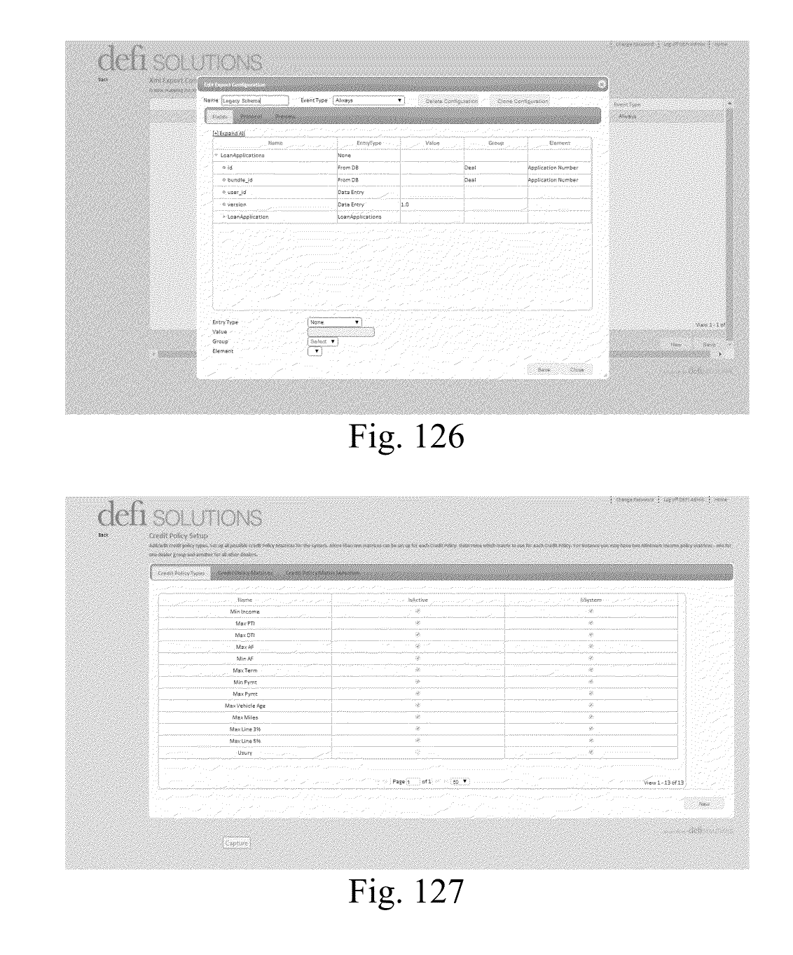

FIG. 126 illustrates a self-service XML screen through which a user may configure loading of data from the system into a data warehouse. Preferably, standard XML for feeding data to a datawarehouse may be preconfigured. In some aspects, a user at a lender may also upload their own format and (preferably instantly) the loan origination system will start sending the lender's date to the data warehouse in that format.

FIG. 127 illustrates a credit policies screen. Preferably, a set of credit policies may be pre-configured. In some aspects, a user at a lender may also (preferably instantly) add their own credit policies. Options may include determining types of credit policies, setting credit policies, setting associated values, CP, setting rules on when to apply the credit policies, and the like.

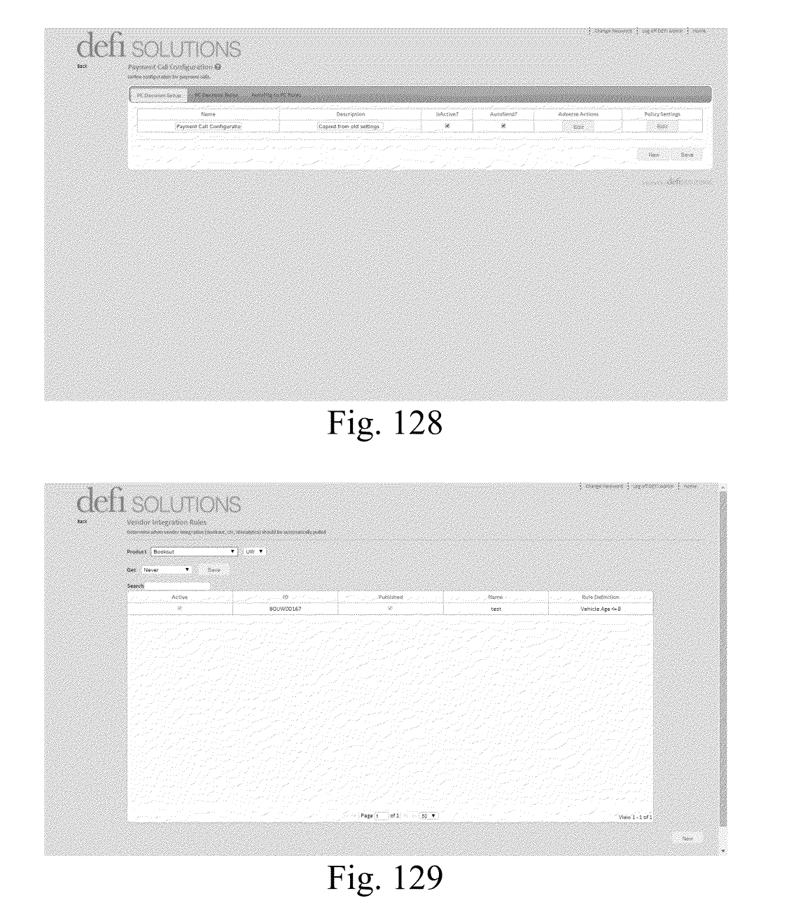

FIG. 128 illustrates a screen for automated payment calls. “Payment calls” are when an application is sent in without a description of a vehicle or other property because a loan applicant desires to know for what payment level they will be approved. In some aspects, the loan origination system may “backsolve” for a maximum payment that would be approved and then automatically send out that information, for example to a dealer. Preferably, a user may configure the system to “flip” collateral calls into payment calls with no further intervention.

FIG. 129 illustrates a screen through which a user may configure vendor integration rules, for example defining when to “pull” third party data such as a credit check. In the illustrated screen, a user picks a type of pull, specifies when the users want information pulled, and defines a rule for pulling the information. The system then behaves accordingly.

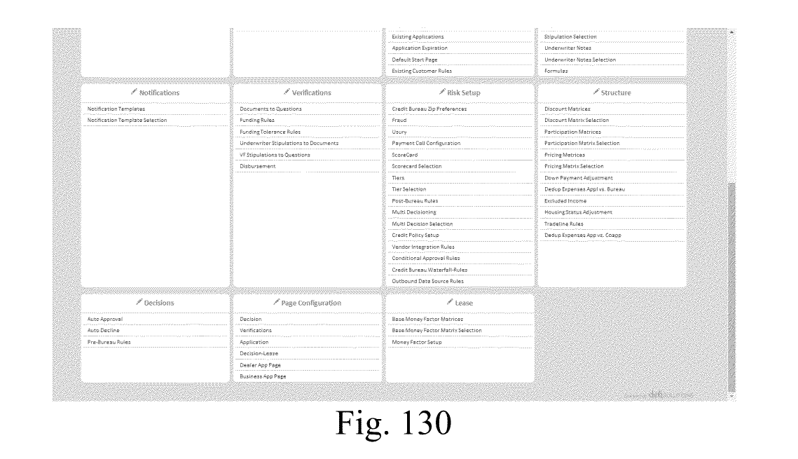

FIG. 130 illustrates that aspects of the subject technology may also be used in a leasing context as well as a loan context. Additional aspects of the subject technology may include configuration pages for Route One Econtracting and DealerTrack DDS and Econtracting. Additional configuration, customization, and features may also be included.

The subject technology may be performed by one or more computing devices including at least a tangible computing element. Examples of a tangible computing element include but are not limited to a microprocessor, application specific integrated circuit, programmable gate array, and the like. A tangible computing element may operate in one or more of a digital, analog, electric, photonic, and/or some other manner. Examples of a computing device include but are not limited to a mobile computing device such as a smart phone or tablet computer, a wearable computing device (e.g., Google® Glass), a laptop computer, a desktop computer, a server, a client that communicates with a server, a smart television, a game counsel, a part of a cloud computing system, a virtualized computing device that ultimately runs on tangible computing elements, or any other form of computing device. The computing device preferably includes or accesses storage for instructions and data used to perform steps such as those discussed above.

Additionally, some operations may be considered to be performed by multiple computing devices. For example, steps of displaying may be considered to be performed by both a local computing device and a remote computing device that instructs the local computing device to display something. For another example, steps of acquiring or receiving may be considered to be performed by a local computing device, a remote computing device, or both. Communication between computing devices may be through one or more other computing devices and/or networks.

The invention is in no way limited to the specifics of any particular embodiments and examples disclosed herein. For example, the terms “aspect,” “example,” “preferably,” “alternatively” and the like denote features that may be preferable but not essential to include in some embodiments of the invention. In addition, details illustrated or disclosed with respect to any one aspect of the invention may be used with other aspects of the invention. Additional elements (e.g., screens) and/or steps may be added to various aspects of the invention and/or some disclosed elements and/or steps may be subtracted from various aspects of the invention without departing from the scope of the invention. Singular elements/steps imply plural elements/steps and vice versa. Some steps may be performed serially, in parallel, in a pipelined manner, or in different orders than disclosed herein. Many other variations are possible which remain within the content, scope and spirit of the invention, and these variations would become clear to those skilled in the art after perusal of this application.

What is claimed is:

1. A customizable loan origination method performed by a computing device including one or more tangible computing elements, comprising:
accepting plural sets of rules for approving or disapproving loans;
accepting information related to at least one set of rules of the plural sets of rules from at least one dealer;
applying at least the one set of rules to the information to decide whether to approve or disapprove a loan; and
providing approval or disapproval of the loan to the dealer.

2. A method as in claim 1, wherein one or more of the rules are based on predefined parameters.

3. A method as in claim 1, wherein one or more of the rules are based on customized parameters.

4. A method as in claim 1, wherein applying the one set of rules to the information further comprises:
displaying a matrix showing plural combinations of the information that result in approved loans and disapproved loans; and
accepting selection of one of the plural loans for approval.

5. A method as in claim 4, wherein the matrix comprises one dimension for each of the rules in the one set of rules; and
wherein displaying the matrix further comprises displaying different views of the matrix as requested.

6. A method as in claim 1, wherein providing approval or disapproval of the loan to the dealer further comprises displaying a matrix to the dealer showing plural combinations of the information that result in approved loans and disapproved loans.

7. A method as in claim 6, wherein the matrix comprises one dimension for each of the rules in the one set of rules; and
wherein displaying the matrix to the dealer further comprises displaying different views of the matrix as requested.

8. A method as in claim 1, further comprising requesting additional information to qualify an approved loan.

9. A method as in claim 8, further comprising sending loan notifications based on the qualified approved loan.

10. A method as in claim 9, further comprising accepting customization of the loan notifications.

11. A loan origination system, comprising:
at least one input interface;
at least one output interface; and
at least one computing device including one or more tangible computing elements that perform steps comprising:
accepting plural sets of rules for approving or disapproving loans;
accepting information related to at least one set of rules of the plural sets of rules from at least one dealer;
applying at least the one set of rules to the information to decide whether to approve or disapprove a loan; and
providing approval or disapproval of the loan to the dealer.

12. A system as in claim 11, wherein one or more of the rules are based on predefined parameters.

13. A system as in claim 11, wherein one or more of the rules are based on customized parameters.

14. A system as in claim 11, wherein applying the one set of rules to the information further comprises:
displaying a matrix showing plural combinations of the information that result in approved loans and disapproved loans; and
accepting selection of one of the plural loans for approval.

15. A system as in claim 14, wherein the matrix comprises one dimension for each of the rules in the one set of rules; and
wherein displaying the matrix further comprises displaying different views of the matrix as requested.

16. A system as in claim 11, wherein providing approval or disapproval of the loan to the dealer further comprises displaying a matrix to the dealer showing plural combinations of the information that result in approved loans and disapproved loans.

17. A system as in claim 16, wherein the matrix comprises one dimension for each of the rules in the one set of rules; and
wherein displaying the matrix to the dealer further comprises displaying different views of the matrix as requested.

18. A system as in claim 11, wherein the steps further comprise requesting additional information to qualify an approved loan.

19. A system as in claim 18, wherein the steps further comprise sending loan notifications based on the qualified approved loan.

20. A system as in claim 19, wherein the steps further comprise accepting customization of the loan notifications.
